SEQUENCE LISTING (15 sequences)

SEQ ID NO: 1 - DNA, 441 bp, Artificial Sequence
  glyphosate-N-acetyltransferase clone 13_6D10
atgattgaagtcaaaccaataaacgcggaagatacgtatgagatcaggcaccgcattctccggccgaatcagccgcttgaagcatgtatgtatgaaaccgattcgctcggaggcacgtttcacctcggtggatattaccggggcaagctgatcagcatcgcttcctttaatcaagccgaacatccagagcttgaaggccaaaaacagtatcagctgagagggatggcgacactcgaagggtaccgtgagcaaaaagcgggaagcacgctcatccgccatgccgaagagcttcttcggaaaaagggggcagacctcttatggtgcaacgccaggacatctgcgagcgggtactataaaaagctcggcttcagcgaacagggcgaagtctacgacacaccgccggtcggacctcatattttgatgtataagaaattgacgtaa

SEQ ID NO: 2 - protein, 146 aa, Artificial Sequence
  glyphosate-N-acetyltransferase clone 13_6D10
MIEVKPINAEDTYEIRHRILRPNQPLEACMYETDSLGGTFHLGGYYRGKLISIASFNQAEHPELEGQKQYQLRGMATLEGYREQKAGSTLIRHAEELLRKKGADLLWCNARTSASGYYKKLGFSEQGEVYDTPPVGPHILMYKKLT

SEQ ID NO: 3 - DNA, 441 bp, Artificial Sequence
  glyphosate-N-acetyltransferase clone 10_4H4
atgctagaggtgaaaccgattaacgcagaggatacctatgaactaaggcataaaatactcagaccaaaccagccgttagaagtgtgtatgtatgaaaccgatttacttcgtggtgcatttcacttaggcggcttttacaggggcaaactgatttccatagcttcattccaccaggccgagcactcagaactccaaggccagaaacagtaccagctccgaggtatggctaccttggaaggttatcgtgagcagaaagcgggatcgagtctaattaaacacgctgaagaaattcttcgtaagaggggggcggacttgctttggtgcaatgcgcggacatccgcctcaggctactacaaaaagttaggcttcagcgagcagggagaggtatttgatacgccgccagtaggacctcacatcctgatgtataaaaggatcacataa

SEQ ID NO: 4 - protein, 146 aa, Artificial Sequence
  glyphosate-N-acetyltransferase clone 10_4H4
MLEVKPINAEDTYELRHKILRPNQPLEVCMYETDLLRGAFHLGGFYRGKLISIASFHQAEHSELQGQKQYQLRGMATLEGYREQKAGSSLIKHAEEILRKRGADLLWCNARTSASGYYKKLGFSEQGEVFDTPPVGPHILMYKRIT

SEQ ID NO: 5 - DNA, 441 bp, Artificial Sequence
  glyphosate-N-acetyltransferase clone 0_5D3
atgctagaggtgaaaccgattaacgcagaggatacctatgaactaaggcatagaatactcagaccaaaccagccgatagaagcgtgtatgtatgaaagcgatttacttcgtggtgcatttcacttaggcggctattacaggggcaaactgatttccatagcttcattccaccaggccgagcactcagaactccaaggccagaaacagtaccagctccgaggtatggctaccttggaaggttatcgtgagcagaaagcgggatcgagtctaattaaacacgctgaagaaattcttcgtaagaggggggcggacttgctttggtgtaatgcgcggacatccgcctcaggctactacaaaaagttaggcttcagcgagcagggagagatatttgaaacgccgccagtaggacctcacatcctgatgtataaaaggatcacataa

SEQ ID NO: 6 - protein, 146 aa, Artificial Sequence
  glyphosate-N-acetyltransferase clone 0_5D3
MLEVKPINAEDTYELRHRILRPNQPIEACMYESDLLRGAFHLGGYYRGKLISIASFHQAEHSELQGQKQYQLRGMATLEGYREQKAGSSLIKHAEEILRKRGADLLWCNARTSASGYYKKLGFSEQGEIFETPPVGPHILMYKRIT

SEQ ID NO: 7 - DNA, 441 bp, Artificial Sequence
  glyphosate-N-acetyltransferase clone D_S00261438_18-28D9
atgatagargtgaaaccgattaacgcagaggatacctatgaactaaggcatagaatactcagaccaaaccagccgatagaagcgtgtatgtttgaaagcgatttacttcgtggtgcatttcacttaggcggcttttacaggggcaaactgatttccatagcttcattccaccaggccgagcactcggaactccaaggccagaaacagtaccagctccgaggtatggctaccttggaaggttatcgtgagcagaaagcgggatcaactctagttaaacacgctgaagaaatccttcgtaagaggggggcggacatgctttggtgtaatgcgcggacatccgcctcaggctactacaaaaagttaggcttcagcgagcagggagagatatttgacacgccgccagtaggacctcacatcctgatgtataaaaggatcacataa

SEQ ID NO: 8 - protein, 146 aa, Artificial Sequence
  glyphosate-N-acetyltransferase clone D_S00261438_18-28D9
MIEVKPINAEDTYELRHRILRPNQPIEACMFESDLLRGAFHLGGFYRGKLISIASFHQAEHSELQGQKQYQLRGMATLEGYREQKAGSTLVKHAEEILRKRGADMLWCNARTSASGYYKKLGFSEQGEIFDTPPVGPHILMYKRIT

SEQ ID NO: 9 - DNA, 444 bp, Artificial Sequence
  glyphosate-N-acetyltransferase clone GAT4621
atggctattgaggttaagcctatcaacgcagaggatacctatgaccttaggcatagagtgctcagaccaaaccagcctatcgaagcctgcatgtttgagtctgaccttactaggagtgcatttcaccttggtggattctacggaggtaaactgatttccgtggcttcattccaccaagctgagcactctgaacttcaaggtaagaagcagtaccagcttagaggtgtggctaccttggaaggttatagagagcagaaggctggttccagtctcgtgaaacacgctgaagagattctcagaaagagaggtgctgacatgatctggtgtaatgccaggacatctgcttcaggatactacaggaagttgggattcagtgagcaaggagaggtgttcgatactcctccagttggacctcacatcctgatgtataagaggatcacataa

SEQ ID NO: 10 - protein, 147 aa, Artificial Sequence
  glyphosate-N-acetyltransferase clone GAT4621
MAIEVKPINAEDTYDLRHRVLRPNQPIEACMFESDLTRSAFHLGGFYGGKLISVASFHQAEHSELQGKKQYQLRGVATLEGYREQKAGSSLVKHAEEILRKRGADMIWCNARTSASGYYRKLGFSEQGEVFDTPPVGPHILMYKRIT

SEQ ID NO: 11 - protein, 455 aa, Agrobacterium sp. Cp4
MSHGASSRPATARKSSGLSGTVRIPGDKSISHRSFMFGGLASGETRITGLLEGEDVINTGKAMQAMGARIRKEGDTWIIDGVGNGGLLAPEAPLDFGNAATGCRLTMGLVGVYDFDSTFIGDASLTKRPMGRVLNPLREMGVQVKSEDGDRLPVTLRGPKTPTPITYRVPMASAQVKSAVLLAGLNTPGITTVIEPIMTRDHTEKMLQGFGANLTVETDADGVRTIRLEGRGKLTGQVIDVPGDPSSTAFPLVAALLVPGSDVTILNVLMNPTRTGLILTLQEMGADIEVINPRLAGGEDVADLRVRSSTLKGVTVPEDRAPSMIDEYPILAVAAAFAEGATVMNGLEELRVKESDRLSAVANGLKLNGVDCDEGETSLVVRGRPDGKGLGNASGAAVATHLDHRIAMSFLVMGLVSENPVTVDDATMIATSFPEFMDLMAGLGAKIELSDTKAA

SEQ ID NO: 12 - DNA, 1968 bp, Glycine max
atgccacacaacacaatggcggccaccgcttccagaaccacccgattctcttcttcctcttcacaccccaccttccccaaacgcattactagatccaccctccctctctctcatcaaaccctcaccaaacccaaccacgctctcaaaatcaaatgttccatctccaaaccccccacggcggcgcccttcaccaaggaagcgccgaccacggagcccttcgtgtcacggttcgcctccggcgaacctcgcaagggcgcggacatccttgtggaggcgctggagaggcagggcgtgacgacggtgttcgcgtaccccggcggtgcgtcgatggagatccaccaggcgctcacgcgctccgccgccatccgcaacgtgctcccgcgccacgagcagggcggcgtcttcgccgccgaaggctacgcgcgttcctccggcctccccggcgtctgcattgccacctccggccccggcgccaccaacctcgtgagcggcctcgccgacgctttaatggacagcgtcccagtcgtcgccatcaccggccaggtcgcccgccggatgatcggcaccgacgccttccaagaaaccccgatcgtggaggtgagcagatccatcacgaagcacaactacctcatcctcgacgtcgacgacatcccccgcgtcgtcgccgaggctttcttcgtcgccacctccggccgccccggtccggtcctcatcgacattcccaaagacgttcagcagcaactcgccgtgcctaattgggacgagcccgttaacctccccggttacctcgccaggctgcccaggccccccgccgaggcccaattggaacacattgtcagactcatcatggaggcccaaaagcccgttctctacgtcggcggtggcagtttgaattccagtgctgaattgaggcgctttgttgaactcactggtattcccgttgctagcactttaatgggtcttggaacttttcctattggtgatgaatattcccttcagatgctgggtatgcatggtactgtttatgctaactatgctgttgacaatagtgatttgttgcttgcctttggggtaaggtttgatgaccgtgttactgggaagcttgaggcttttgctagtagggctaagattgttcacattgatattgattctgccgagattgggaagaacaagcaggcgcacgtgtcggtttgcgcggatttgaagttggccttgaagggaattaatatgattttggaggagaaaggagtggagggtaagtttgatcttggaggttggagagaagagattaatgtgcagaaacacaagtttccattgggttacaagacattccaggacgcgatttctccgcagcatgctatcgaggttcttgatgagttgactaatggagatgctattgttagtactggggttgggcagcatcaaatgtgggctgcgcagttttacaagtacaagagaccgaggcagtggttgacctcagggggtcttggagccatgggttttggattgcctgcggctattggtgctgctgttgctaaccctggggctgttgtggttgacattgatggggatggtagtttcatcatgaatgttcaggagttggccactataagagtggagaatctcccagttaagatattgttgttgaacaatcagcatttgggtatggtggttcagttggaggataggttctacaagtccaatagagctcacacctatcttggagatccgtctagcgagagcgagatattcccaaacatgctcaagtttgctgatgcttgtgggataccggcagcgcgagtgacgaagaaggaagagcttagagcggcaattcagagaatgttggacacccctggcccctaccttcttgatgtcattgtgccccatcaggagcatgtgttgccgatgattcccagtaatggatccttcaaggatgtgataactgagggtgatggtagaacgaggtac

SEQ ID NO: 13 - DNA, 1917 bp, Zea mays
cagtacacagtcctgccatcaccatccaggatcatatccttgaaagccccaccactagggatcataggcaacacatgctcctggtgtgggacgattatatccaagaggtacggccctggagtctcgagcatcttctttatcgctgcgcggacttcgttcttctttgtcacacggaccgctggaatgttgaaccctttggcgatcgtcacgaaatctggatatatctcactttcattctctgggtttcccaagtatgtgtgcgctctgttggccttatagaacctgtcctccaactgcaccaccatccccaggtgctggttgtttagcacaaagaccttcactgggaggttctcaattcggatcatagctagctcctgaacgttcatgagaaagctaccatctccatcgatgtcaacaacagtgacacctgggtttgccacagaagcaccagcagcagccggcaaaccaaatcccatagccccaagaccagctgaagacaaccactgccttggccgcttgtaagtgtagtactgtgccgcccacatctggtgctgcccaacacctgtgccgatgatggcctcgcctttcgtcagctcatcaagaacctgaatagcatattgtggctggatctcctcattagatgttttatacccaagggggaattccctcttctgctgatccaactcatcgttccatgagccaaagtcaaagctcttctttgatgtgcttccttcaagaagagcattcatgccctgcaaagcaagcttaacatctgcacagatggacacatgtggctgcttgttcttgccaatctcagccggatcaatatcaacgtgcacaatcttagccctgcttgcaaaagcctcaatcttccctgtcacgcgatcatcaaaccgcacaccaagtgcaagcaacagatcggccttatccactgcataatttgcatacaccgtcccatgcatacctagcatgcgcagagacagtgggtcgtcgctggggaagttgccgaggcccataagagtagttgtgaccgggattccagtcagctccacaaagcgtcgcaactcctcaccagatgctgcgcagccaccgcccacataaagaacagggcgccgcgattcaccaacaagacgcagcacctgctcaagcaactcagtcgcagggggcttgggaaggcgcgcaatgtacccaggcagactcatgggcttgtcccagacaggcaccgccatctgctgctggatgtccttggggatgtcgacaagcaccggccctggtcgaccagaggaggcgaggaagaaagcctcctgcacgacgcgggggatgtcgtcgacgtcgaggaccaggtagttgtgcttggtgatggagcgggtgacctcgacgatgggcgtctcctggaaggcgtcggtgccaatcatgcgtcgcgccacctgtcccgtgatggcgaccatggggacggaatcgagcagcgcgtcggcgagcgcggagactaggttggtggcgccggggccggaggtggcgatgcagacgccgacgcggcccgaggagcgcgcgtagccggaggcggcaaaggcctccccttgctcgtggcggaagaggtggttggcgatgacgggggagcgggtgagtgcctggtggatctccatggacgcgccgccggggtaggcgaagacgtcgcggacgccgcagcgctcgagggactcgacgaggatgtcagcacccttgcggggctcggtggggccccacggccggagcggggtggccgggggagccatcggcatggcgggtgacgccgctgagcacctgatgggcgcggcgagggcgcggcgggtggccaggaggtgcgcccggcgcctcgccttgggcgcagcggtagtggcgccagtgagcgcggtagacgcggcggcggcggtggccatg

SEQ ID NO: 14 - DNA, 2139 bp, Arabidopsis
aaatacgtacctacgcaccctgcgctaccatccctagagctgcagcttatttttacaacaattaccaacaacaacaaacaacaaacaacattacaattactatttacaattacagtcgacccgggatccatggcggcggcaacaacaacaacaacaacatcttcttcgatctccttctccaccaaaccatctccttcctcctccaaatcaccattaccaatctccagattctccctcccattctccctaaaccccaacaaatcatcctcctcctcccgccgccgcggtatcaaatccagctctccctcctccatctccgccgtgctcaacacaaccaccaatgtcacaaccactccctctccaaccaaacctaccaaacccgaaacattcatctcccgattcgctccagatcaaccccgcaaaggcgctgatatcctcgtcgaagctttagaacgtcaaggcgtagaaaccgtattcgcttaccctggaggtgcatcaatggagattcaccaagccttaacccgctcttcctcaatccgtaacgtccttcctcgtcacgaacaaggaggtgtattcgcagcagaaggatacgctcgatcctcaggtaaaccaggtatctgtatagccacttcaggtcccggagctacaaatctcgttagcggattagccgatgcgttgttagatagtgttcctcttgtagcaatcacaggacaagtcgctcgtcgtatgattggtacagatgcgtttcaagagactccgattgttgaggtaacgcgttcgattacgaagcataactatcttgtgatggatgttgaagatatccctaggattattgaggaagctttctttttagctacttctggtagacctggacctgttttggttgatgttcctaaagatattcaacaacagcttgcgattcctaattgggaacaggctatgagattacctggttatatgtctaggatgcctaaacctccggaagattctcatttggagcagattgttaggttgatttctgagtctaagaagcctgtgttgtatgttggtggtggttgtttgaattctagcgatgaattgggtaggtttgttgagcttacggggatccctgttgcgagtacgttgatggggctgggatcttatccttgtgatgatgagttgtcgttacatatgcttggaatgcatgggactgtgtatgcaaattacgctgtggagcatagtgatttgttgttggcgtttggggtaaggtttgatgatcgtgtcacgggtaagcttgaggcttttgctagtagggctaagattgttcatattgatattgactcggctgagattgggaagaataagactcctcatgtgtctgtgtgtggtgatgttaagctggctttgcaagggatgaatatgattcttgagagccgagcggaggagcttaagcttgattttggagtttggaggaatgagttgaacgtacagaaacagaagtttccgttgagctttaagacgtttggggaagctattcctccacagtatgcgattaaggtccttgatgagttgactgatggaaaagccataataagtactggtgtcgggcaacatcaaatgtgggcggcgcagttctacaattacaagaaaccaaggcagtggctatcatcaggaggccttggagctatgggatttggacttcctgctgcgattggagcgtctgttgctaaccctgatgcgatagttgtggatattgacggagatggaagctttataatgaatgtgcaagagctagccactattcgtgtagagaatcttccagtgaaggtacttttattaaacaaccagcatcttggcatggttatgcaattggaagatcggttctacaaagctaaccgagctcacacatttctcggggatccggctcaggaggacgagatattcccgaacatgttgctgtttgcagcagcttgcgggattccagcggcgagggtgacaaagaaagcagatctccgagaagctattcagacaatgctggatacaccaggaccttacctgttggatgtgatttgtccgcaccaagaacatgtgttgccgatgatcccgagtggtggcactttcaacgatgtcataacggaaggagatggccggattaaatac

SEQ ID NO: 15 - protein, 657 aa, Gossypium hirsutum
MAPHNTMAATASRTTRFSSSSSHPTFPKRITRSTLPLSHQTLTKPNHALKIKCSISKPPTAAPFTKEAPTTEPFVSRFASGEPRKGADILVEALERQGVTTVFAYPGGASMEIHQALTRSAAIRNVLPRHEQGGVFAAEGYARSSGLPGVCIATSGPGATNLVSGLADALMDSVPVVAITGQVARRMIGTDAFQETPIVEVSRSITKHNYLILDVDDIPRVVAEAFFVATSGRPGPVLIDIPKDVQQQLAVPNWDEPVNLPGYLARLPRPPAEAQLEHIVRLIMEAQKPVLYVGGGSFNSSAELRRFVELTGIPVASTLMGLGTFPIGDEYSLQMLGMHGTVYANYAVDNSDLLLAFGVRFDDRVTGKLEAFASRAKIVHIDIDSAEIGKNKQAHVSVCADLKLALKGINMILEEKGVEGKFDLGGWREEINVQKHKFPLGYKTFQDAISPQHAIEVLDELTNGDAIVSTGVGQHQMWAAQFYKYKRPRQWLTSGGLGAMGFGLPAAIGAAVANPGAVVVDIDGDGSFIMNVQELATIRVENLPVKILLLNNQHLGMVVQLEDRFYKSNRAHTYLGDPSSESEIFPNMLKFADACGIPAARVTKKEELRAAIQRMLDTPGPYLLDVIVPHQEHVLPMIPSNGSFKDVITEGDGRTRY

(19) United States
(12) Patent Application Publication
(10) Pub. No.: US 2009/0011938 A1
(43) Pub. Date: Jan. 8, 2009

(54) NOVEL GLYPHOSATE-N-ACETYLTRANSFERASE (GAT) GENES

(75) Inventors: Linda A. Castle, Mountain View, CA (US); Yong Hong Chen, Foster City, CA (US); Nicholas B. Duck, Apex, NC (US); Lorraine Giver, Sunnyvale, CA (US); Cristina Ivy, Encinitas, CA (US); Roger Kemble, Wake Forest, NC (US); Billy Fred McCutchen, Cameron, TX (US); Jeremy Minshull, Los Altos, CA (US); Phillip A. Patten, Menlo Park, CA (US); Dan Siehl, Menlo Park, CA (US)

Correspondence Address: ALSTON & BIRD LLP;PIONEER HI-BRED INTERNATIONAL, INC., BANK OF AMERICA PLAZA, 101 SOUTH TRYON STREET, SUITE 4000, CHARLOTTE, NC, 28280-4000, US

(73) Assignees: Pioneer Hi--Bred International, Inc., Johnston, IA (US); E.I. du Pont de Nemours and Company, Wilmington, DE (US)

(21) Appl. No.: 12/129,947

(22) Filed: May 30, 2008

Related U.S. Application Data
(63) Continuation-in-part of application No. 10/427,692, filed on Apr. 30, 2003.
Application No. 10/427,692 is a continuation-in-part of application No. 10/004,357, filed on Oct. 29, 2001, now abandoned.
(60) Provisional application No. 60/377,719, filed on Apr. 30, 2002.
(60) Provisional application No. 60/377,175, filed on May 1, 2002.
(60) Provisional application No. 60/244,385, filed on Oct. 30, 2000.

(51) Int. Cl. A01N 57/20; A01P 21/00

(52) U.S. Cl. 504/206

(57) ABSTRACT

Methods and compositions for improving yield in a plant are provided. Methods of improving yield include treating plants with an effective amount of glyphosate, wherein the plant express at least two heterologous polypeptides that impart tolerance to glyphosate via distinct modes of action. In one non-limiting method, the first polypeptide has glyphosate N-acetyl transferase activity and the second polypeptide comprises a glyphosate-tolerant EPSPS polypeptide.

### CROSS-REFERENCE TO RELATED APPLICATIONS

This application is a continuation-in-part of co-pending U.S. application Ser. No. 10/427,692, filed Apr. 30, 2003, which claims the benefit of U.S. Provisional Patent Application No. 60/377,719 filed Apr. 30, 2002, and U.S. Provisional Patent Application No. 60/377,175 filed May 1, 2002, and is a continuation-in-part of U.S. application Ser. No. 10/004,357 filed Oct. 29, 2001, now abandoned, which claims priority to U.S. Provisional Application No. 60/244,385 filed Oct. 30, 2000, each of which is incorporated in its entirety by reference herein.

### FIELD OF THE INVENTION

This invention is in the field of molecular biology, more particularly plant molecular biology and methods to improve yield of plants.

### REFERENCE TO A SEQUENCE LISTING SUBMITTED AS A TEXT FILE VIA EFS-WEB

The official copy of the sequence listing is submitted concurrently with the specification as a text file via EFS-Web, in compliance with the American Standard Code for Information Interchange (ASCII), with a file name of 341199seqlist.txt, a creation date of May 29, 2008, and a size of 28 Kb. The sequence listing filed via EFS-Web is part of the specification and is hereby incorporated in its entirety by reference herein.

### BACKGROUND OF THE INVENTION

The ever-increasing world population and the dwindling supply of arable land available for agriculture fuel research towards improving the efficiency of agriculture. Conventional means for crop and horticultural improvements utilize selective breeding techniques to identify plants having desirable characteristics. However, such selective breeding techniques have several drawbacks, namely that these techniques are typically labor intensive and result in plants that often contain heterogeneous genetic components that may not always result in the desirable trait being passed on from parent plants. The application of recombinant techniques to improve crop quality and yield is not only desirable but also has potential to open up new opportunities. Although there has been significant progress in developing technologies for improving these traits, this remains an important challenge for plant biotechnology.

### SUMMARY OF THE INVENTION

Methods and compositions for increasing yield in a plant are provided. Compositions comprise plants having sequences that impart multi-“mode of action” glyphosate-tolerance to the plants. Methods of increasing yield include treating these plants expressing at least two heterologous polypeptides that impart tolerance to glyphosate via distinct modes of action with an effective amount of glyphosate, and thereby increasing yield. In one non-limiting embodiment, the first polypeptide has glyphosate N-acetyl transferase (GLYAT) activity and the second polypeptide encodes a glyphosate-tolerant 5-enol-pyruvylshikimate-3-phosphate synthase (EPSPS) polypeptide.

### BRIEF DESCRIPTION OF THE DRAWINGS

FIG. 1. LSMean comparisons for yield (bu/ac) of ten different populations of lines classified for glyphosate tolerance transgenes (GLYAT, EPSPS, GLYAT+EPSPS). Lines are adapted to the Southern United States growing region.

FIG. 2. LSMean comparisons for yield of two different populations of related lines classified for glyphosate tolerance transgenes (GLYAT, EPSPS, GLYAT+EPSPS). Lines are adapted to the Midwestern United States growing region.

### DETAILED DESCRIPTION OF THE INVENTION

The presently disclosed subject matter now will be described more fully hereinafter with reference to the accompanying drawings, in which some, but not all embodiments of the presently disclosed subject matter are shown. Indeed, the presently disclosed subject matter can be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims. Although specific terms are employed herein, they are used in a generic and descriptive sense only and not for purposes of limitation

Methods and compositions for increasing yield in a plant are provided. Specifically, glyphosate tolerate plants are provided which comprise sequences encoding at least two polypeptides, wherein each of the polypeptides imparts tolerance to glyphosate via a distinct mode of action. Such plants produce an increase in yield in the presence of an effective amount of glyphosate when compared to an appropriate control plant. Accordingly, further provided are various methods of increasing yield employing such plants.

As used herein, the term “yield” refers to the measureable produce of economic value from a crop. This term may be defined in terms of quantity and/or quality. As used herein, the term “improved yield” means any improvement in the yield of any measured plant product when compared to an appropriate control. The improvement in yield can comprise an increase between about 0.1% to about 90%, about 0.5% to about 10%, about 10% to about 20%, about 20% to about 30%, about 30% to about 40%, about 40% to about 50%, about 50% to about 60%, about 60% to about 70%, about 70% to about 80%, about 80% to about 90% or greater increase in measured plant product. In other embodiments, the increase in yield can comprise at least a 0.1%. 0.5%, 1%, 3%, 5%. 10%, 15%, 20%, 30%, 40%, 50%, 60%, 70%, 80%, 90% or greater increase in the measured plant product. Alternatively, the improved plant yield can comprise between a 0.1 fold to 64 fold, about a 0.1 fold to about a 10 fold, about a 10 fold to about a 20 fold, about a 20 fold to about a 30 fold, about a 30 fold to about a 40 fold, about a 40 fold to about a 50 fold, about a 50 fold to about a 60 fold, about a 60 fold to about a 64 fold increase in measured plant products.

An improved yield relative to a proper control plant can be measured as (i) increased biomass (weight) of one or more parts of a plant, including aboveground parts or increased biomass of any other harvestable part; (ii) increased seed yield, which includes an increase in seed biomass (seed weight) and which may be an increase in the seed weight per plant or on an individual seed basis or an increase in seed weight per hectare or acre; (iii) increased number of flowers (florets) per panicle, which is expressed as a ratio of the number of filled seeds over the number of primary panicles; (iv) increased number of (filled) seeds; (v) increased fill rate of seeds (which is the number of filled seeds divided by the total number of seeds and multiplied by 100); (vi) increased seed size, which may also influence the composition of seeds; (vii) increased seed volume, which may also influence the composition of seeds (for example due to an increase in amount or a change in the composition of oil, protein or carbohydrate); (viii) increased seed area; (ix) increased seed length; (x) increased seed width; (x) increased seed perimeter; (xi) increased harvest index, which is expressed as a ratio of the yield of harvestable parts, such as seeds, over the total biomass; and (xii) increased thousand kernel weight (TKW), which is extrapolated from the number of filled seeds counted and their total weight. An increased TKW may result from an increased seed size and/or seed weight and may also result from an increase in embryo size and/or endosperm size. For example, an increase in the bu/acre yield of soybeans or corn derived from a crop having sequence that confer a multi-mode of action glyphosate tolerance as compared with the bu/acre yield from soybeans or corn having only one of the glyphosate tolerant sequences cultivated under the same conditions would be considered an improved yield.

### I. Multi-Mode of Action Glyphosate Tolerant Plants

Plants are provided which comprise at least two heterologous polynucleotides which encode polypeptides that confer tolerance to glyphosate via distinct modes of action. A “glyphosate-tolerance polypeptide” is a polypeptide that confers glyphosate tolerance on a plant (i.e., that makes a plant glyphosate-tolerant), and a “glyphosate-tolerance polynucleotide” is a polynucleotide that encodes a glyphosate-tolerance polypeptide.

“Mode of action” refers to the specific metabolic or physiological process within the plant by which the glyphosate-tolerant polypeptide acts to protect the plant from glyphosate. Thus, polypeptides having “distinct” modes of action for providing glyphosate tolerance comprise any two or more polypeptides that protect a plant from glyphosate by a number of mechanisms including detoxifying the chemical via different metabolic or physiological processes. For example, glyphosate N-acetyl transferase polypeptides acetylate glyphosate and thereby detoxify the herbicide, while glyphosate-tolerant EPSPS polypeptides prevent or decrease the ability of glyphosate to inhibit the shikimic acid pathway. In light of the distinct mechanism of action of these two enzymes, these polypeptides represent two non-limiting examples of polypeptides that confer tolerance to glyphosate via distinct modes of action.

a. Glyphosate N-Acetyl Transferase Sequences

In one embodiment, one of the mechanisms of glyphosate tolerance in the plant is provided by the expression of a polynucleotide having transferase activity. As used herein, a “transferase” polypeptide has the ability to transfer the acetyl group from acetyl CoA to the N of glyphosate, transfer the propionyl group of propionyl CoA to the N of glyphosate, or to catalyze the acetylation of glyphosate analogs and/or glyphosate metabolites, e.g., aminomethylphosphonic acid. Methods to assay for this activity are disclosed, for example, in U.S. Publication No. 2003/0083480, U.S. Publication No. 2004/0082770, and U.S. application Ser. No. 10/835,615, filed Apr. 29, 2004, WO2005/012515, WO2002/36782 and WO2003/092360. In one embodiment, the transferase polypeptide comprises a glyphosate-N-acetyltransferase or “GLYAT” polypeptide.

As used herein, a GLYAT polypeptide or enzyme comprises a polypeptide which has glyphosate-N-acetyltransferase activity (“GLYAT” activity), i.e., the ability to catalyze the acetylation of glyphosate. In specific embodiments, a polypeptide having glyphosate-N-acetyltransferase activity can transfer the acetyl group from acetyl CoA to the N of glyphosate. In addition, some GLYAT polypeptides transfer the propionyl group of propionyl CoA to the N of glyphosate. Some GLYAT polypeptides are also capable of catalyzing the acetylation of glyphosate analogs and/or glyphosate metabolites, e.g., aminomethylphosphonic acid. GLYAT polypeptides are characterized by their structural similarity to one another, e.g., in terms of sequence similarity when the GLYAT polypeptides are aligned with one another. Exemplary GLYAT polypeptides and the polynucleotides encoding them are known in the art and particularly disclosed, for example, in U.S. application Ser. No. 10/004,357, filed Oct. 29, 2001, U.S. application Ser. No. 10/427,692, filed Apr. 30, 2003, and U.S. application Ser. No. 10/835,615, filed Apr. 29, 2004, each of which is herein incorporated by reference in its entirety. In some embodiments, GLYAT polypeptides used in creating plants of the invention comprise the amino acid sequence set forth in: SEQ ID NO: 2, 4, 6, 8, or 10. Each of these sequences is also disclosed in U.S. application Ser. No. 10/835,615, filed Apr. 29, 2004. In some embodiments, the corresponding GLYAT polynucleotides that encode these polypeptides are used; these polynucleotide sequences are set forth in SEQ ID NO: 1, 3, 5, 7, or 9. Each of these sequences is also disclosed in U.S. application Ser. No. 10/835,615, filed Apr. 29, 2004. As discussed in further detail elsewhere herein, the use of fragments and variants of GLYAT polynucleotides and other known herbicide-tolerance polynucleotides and polypeptides encoded thereby is also encompassed by the present invention.

In specific embodiments, the glyphosate tolerant plants express a GLYAT polypeptide, i.e., a polypeptide having glyphosate-N-acetyltransferase activity wherein the acetyl group from acetyl CoA is transferred to the N of glyphosate. Thus, plants of the invention that have been treated with glyphosate can contain the metabolite N-acetylglyphosate (“NAG”).

The plants of the invention can comprise multiple GLYAT polynucleotides (i.e., at least 1, 2, 3, 4, 5, 6 or more). It is recognized that if multiple GLYAT polynucleotides are employed, the GLYAT polynucleotides may encode GLYAT polypeptides having different kinetic parameters, i.e., a GLYAT variant having a lower Kₘ can be combined with one having a higher k_{cat}. In some embodiments, the different polynucleotides may be coupled to a chloroplast transit sequence or other signal sequence thereby providing polypeptide expression in different cellular compartments, organelles or secretion of one or more of the polypeptides.

The GLYAT polypeptide encoded by a GLYAT polynucleotide may have improved enzymatic activity in comparison to previously identified enzymes. Enzymatic activity can be characterized using the conventional kinetic parameters k_{cat}, K_{M}, and k_{cat}/K_{M}. k_{cat} can be thought of as a measure of the rate of acetylation, particularly at high substrate concentrations; K_{M} is a measure of the affinity of the GLYAT enzyme for its substrates (e.g., acetyl CoA, propionyl CoA and glyphosate); and k_{cat}/K_{M} is a measure of catalytic efficiency that takes both substrate affinity and catalytic rate into account. k_{cat}/Kₘ is particularly important in the situation where the concentration of a substrate is at least partially rate-limiting. In general, a GLYAT with a higher k_{cat} or k_{cat}/K_{M} is a more efficient catalyst than another GLYAT with lower k_{cat} or k_{cat}/K_{M}. A GLYAT with a lower K_{M} is a more efficient catalyst than another GLYAT with a higher K_{M}. Thus, to determine whether one GLYAT is more effective than another, one can compare kinetic parameters for the two enzymes. The relative importance of k_{cat}, k_{cat}/K_{M} and K_{M} will vary depending upon the context in which the GLYAT will be expected to function, e.g., the anticipated effective concentration of glyphosate relative to the K_{M} for glyphosate. GLYAT activity can also be characterized in terms of any of a number of functional characteristics, including but not limited to stability, susceptibility to inhibition, or activation by other molecules.

Thus, for example, the GLYAT polypeptide may have a lower K_{M} for glyphosate than previously identified enzymes, for example, less than 1 mM, 0.9 mM, 0.8 mM, 0.7 mM, 0.6 mM, 0.5 mM, 0.4 mM, 0.3 mM, 0.2 mM, 0.1 mM, 0.05 mM, or less. The GLYAT polypeptide may have a higher k_{cat} for glyphosate than previously identified enzymes, for example, a k_{cat} of at least 500 min⁻¹, 1000 min⁻¹, 1100 min⁻¹, 1200 min⁻¹, 1250 min⁻¹, 1300 min⁻¹, 1400 min⁻¹, 1500 min⁻¹, 1600 min⁻¹, 1700 min⁻¹, 1800 min⁻¹, 1900 min⁻¹, or 2000 min⁻¹ or higher. GLYAT polypeptides for use in the invention may have a higher k_{cat}/K_{M} for glyphosate than previously identified enzymes, for example, a k_{cat}/K_{M} of at least 1000 mM⁻¹ min⁻¹, 2000 mM⁻¹ min⁻¹, 3000 mM⁻¹ min⁻¹, 4000 mM⁻¹ min⁻¹, 5000 mM⁻¹ min⁻¹, 6000 mM⁻¹ min⁻¹, 7000 mM⁻¹ min⁻¹, or 8000 mM⁻¹ min⁻¹, or higher. The activity of GLYAT enzymes is affected by, for example, pH and salt concentration; appropriate assay methods and conditions are known in the art (see, e.g., WO2005012515). Such improved enzymes may find particular use in methods of growing a crop in a field where the use of a particular herbicide or combination of herbicides and/or other agricultural chemicals would result in damage to the plant if the enzymatic activity (i.e., k_{cat}, K_{M}, or k_{cat}/K_{M}) were lower.

b. 5-enolpyruvylshikimate-3-phosphate synthase (EPSPS) Sequences

Glyphosate specifically binds to and blocks the activity of 5-enolpyruvylshikimate-3-phosphate synthase (EPSP synthase, EPSPS) (E.C. 2.5.1.19), an enzyme of the aromatic amino acid biosynthetic pathway. EPSPS catalyzes the reaction shikimate-3-phosphate (S3P) and phosphoenolpyruvate (PEP) to form 5-enolpyruvylshikimate-3-phosphate (EPSP) and phosphate. Glyphosate inhibition of EPSPS thus prevents the plant from making the aromatic amino acids essential for the synthesis of proteins and some secondary metabolites.

As used herein, an “EPSPS glyphosate tolerance polypeptide” prevents or decreases the ability of glyphosate to inhibit the shikimic acid pathway and thereby confers tolerance to glyphosate. Such sequences are known in the art. Non-limiting examples, include, specific mutations of EPSPS (Franz et al. (1997) Glyphosate: A Unique Global Herbicide, pp. 441-519 and 617-642, American Chemical Society, Washington, D.C. and Stalker et al. (1985) J. Biol. Chem. 260, 4724-4728), including T42M (He et al. (2003) Biosci. Biotechnol. Biochem. 67: 1405-1409); G96A (Padgette et al. (1991) J. Biol. Chem. 266: 22364-22369 and Eschenburg et al. (2002) Planta 216: 129-135); T97I (U.S. Pat. No. 6,040,497); P101L, P101T, P101A, and P101S (Padgette et al. (1991) J. Biol. Chem. 266: 22364-22369; Wakelin et al. (2004) Weed Res. 44: 453-459; Ng et al. (2003) Weed Res. 43: 108-115; Yu et al. (2007) Planta 225: 499-513; Perez-Jones et al. (2007) Planta 226: 395-404; and, Baerson et al. (2002) Plant Physiol. 129: 1265-1275); and A183 T (U.S. Pat. No. 6,225,114 and Kahrizi et al. (2007) Plant Cell Rep. 26: 95-104) (all numbering according to E. coli EPSPS).

Additional EPSPS sequences that are tolerant to glyphosate are described in U.S. Pat. Nos. 6,248,876; 5,627,061; 5,804,425; 5,633,435; 5,145,783; 4,971,908; 5,312,910; 5,188,642; 4,940,835; 5,866,775; 6,225,114; 6,130,366; 5,310,667; 4,535,060; 4,769,061; 5,633,448; 5,510,471; Re. 36,449; RE 37,287 E; and U.S. Pat. No. 5,491,288; and international publications WO 97/04103; WO 00/66746; WO 01/66704; and WO 00/66747; U.S. Pat. Nos. 6,040,497; 5,094,945; 5,554,798; 6,040,497; Zhou et al. (1995) Plant Cell Rep.: 159-163; WO 0234946; WO 9204449; U.S. Pat. Nos. 6,225,112; 4,535,060, and 6,040,497, which are incorporated herein by reference in their entireties for all purposes. Additional EPSP synthase sequences include, gdc-1 (U.S. App. Publication 20040205847); EPSP synthases with class III domains (U.S. App. Publication 20060253921); gdc-1 (U.S. App. Publication 20060021093); gdc-2 (U.S. App. Publication 20060021094); gro-1 (U.S. App. Publication 20060150269); grg23 or grg 51 (U.S. App. Publication 20070136840); GRG32 (U.S. App. Publication 20070300325); GRG33, GRG35, GRG36, GRG37, GRG38, GRG39 and GRG50 (U.S. App. Publication 20070300326); or EPSP synthase sequences disclosed in, U.S. App. Publication 20040177399; 20050204436; 20060150270; 20070004907; 20070044175; 2007010707; 20070169218; 20070289035; and, 20070295251; each of which is herein incorporated by reference in their entirety.

In one non-limiting embodiment, the glyphosate-tolerant EPSPS sequence employed is the EPSPS polypeptide from Agrobacterium sp. Strain CP4 as described in Pagette et al (1995) Development, Identification, and Characterization of a Glyphosate-Tolerance Soybean Line. Crop Sci. 35:1451-1461, herein incorporated by reference in its entirety. In still further embodiments, the EPSPS sequence from the glyphosate-tolerant soybean line 40-3-2 is combined with a GLYAT sequence in planta.

In still further non-limiting embodiments, the glyphosate tolerant EPSPS sequence of the NK603 event (U.S. Pat. No. 6,825,400) or the GA21 event or other events disclosed in U.S. Pat. No. 6,040,497 or the GT73 event, all of which are herein incorporated by reference in their entirety.

In Z. mays, the following EPSPS events can be used. SYN-BT011-1, SYN-IR604-5, MON-00021-9 having glyphosate tolerant EPSPS from Z. mays; DAS-59122-7, MON-00603-6 (DAS-59122-7 X NK603) having CP4 EPSPS from Agrobacterium tumefaciens CP4; DAS-59122-7, DAS-01507-1, MON-00603-6 having CP4 EPSPS from Agrobacterium tumefaciens CP4; DAS-01507-1×MON-00603-6 having CP4 EPSPS from Agrobacterium tumefaciens CP4; MON-0021-9 having glyphosate tolerant EPSPS from Z. mays; SYN-IR604-5, MON00021-9 having glyphosate tolerant EPSPS from Z. mays; MON-00603-6×MON-00810-6 having CP4 EPSPS from Agrobacterium tumefaciens CP4; MON-00863-5×MON-00603-6 having CP4 EPSPS from Agrobacterium tumefaciens CP4; MON-00863-5×MON-00810-6×MON-00603-6 having CP4 EPSPS from Agrobacterium tumefaciens CP4; MON-00021-9×MON-00810-6 having glyphosate tolerant EPSPS from Z. mays; MON802 having CP4 EPSPS from Agrobacterium tumefaciens CP4; MON809 having CP4 EPSPS from Agrobacterium tumefaciens CP4; MON-88017-3, MON-00810-6 having CP4 EPSPS from Agrobacterium tumefaciens CP4; and MON832 having CP4 EPSPS from Agrobacterium tumefaciens CP4.

In Agrostis stolonifera (Creeping Bentgrass) ASR368 having CP4 EPSPS from Agrobacterium tumefaciens CP4 can be used. In Beta vulgaris (Sugar Beet), GTSB77 having CP4 EPSPS from Agrobacterium tumefaciens CP4 or KM-00071-4 (H7-1) having CP4 EPSPS from Agrobacterium tumefaciens CP4 can be used. In Brassica napus (Argentine Canola) MON89249-2 (GT200) having CP4 EPSPS from Agrobacterium tumefaciens CP4 or MON-00073-7 (GT73, RT73) having CP4 EPSPS from Agrobacterium tumefaciens CP4 can be used. In Brassica rapa (Polish Canola) ZSR500/502 having CP4 EPSPS from Agrobacterium tumefaciens CP4 can be used. In Glycine max L. (Soybean), MON-04032-6 (GTS 40-3-2) having CP4 EPSPS from Agrobacterium tumefaciens CP4 or MON-89788-1 (MON89788) having CP4 EPSPS from Agrobacterium tumefaciens CP4 can be used. In Gossypium hirsutum L. (Cotton) the following events can be used: DAS-21023-5, DAS-24236-5, MON-01445-2 having CP4 EPSPS from Agrobacterium tumefaciens CP4; DAS-24236-5, DAS-21023-5, MON-88913-8 having CP4 EPSPS from Agrobacterium tumefaciens CP4; MON-15985-7×MON-01445-2 having CP4 EPSPS from Agrobacterium tumefaciens CP4; MON-00531-6×MON-01445-2 having CP4 EPSPS from Agrobacterium tumefaciens CP4; MON-01445-2 (MON1445/1698) having CP4 EPSPS from Agrobacterium tumefaciens CP4; MON-15985-7×MON-88913-8 having CP4 EPSPS from Agrobacterium tumefaciens CP4; or MON-88913-8 (MON88913) having CP4 EPSPS from Agrobacterium tumefaciens CP4. In Medicago sativa (Alfalfa), MON-00101-8, MON-00163-7 (J101, J163) having CP4 EPSPS from Agrobacterium tumefaciens CP4. In Triticum aestivum (Wheat), MON71800 having CP4 EPSPS from Agrobacterium tumefaciens CP4. Additional information regarding these events and other EPSPS events of interest can be found at www.agbios.com/main.php.

c. Glyphosate Oxido-Reductase

Glyphosate resistance can also be imparted to plants that express a gene that encodes a glyphosate oxido-reductase enzyme as described more fully in U.S. Pat. Nos. 5,776,760 and 5,463,175, which are incorporated herein by reference in their entireties for all purposes. Such enzymes detoxify glyphosate through the degradation of glyphosate into AMPA.

d. Additional Traits of Interest

The multi-mode of action glyphosate tolerant plants of the invention can further comprises additional traits of interest. Such traits, for example, can include sequences which confer tolerance to additional herbicides. In some embodiments, a composition of the invention (e.g., a plant) may comprise two, three, four, five, six, seven, or more traits which confer tolerance to at least one herbicide, so that a plant of the invention may be tolerant to at least two, three, four, five, six, or seven or more different types of herbicides. Thus, a plant of the invention that is tolerant to more than two different herbicides may be tolerant to herbicides that have different modes of action and/or different sites of action. In some embodiments, all of these traits are transgenic traits, while in other embodiments, at least one of these traits is not transgenic.

In specific embodiments, the multi-mode of action glyphosate tolerant plants further comprise a polynucleotide encoding an acetolactate synthase (ALS) inhibitor-tolerant polypeptide. As used herein, an “ALS inhibitor-tolerant polypeptide” comprises any polypeptide which when expressed in a plant confers tolerance to at least one ALS inhibitor herbicide. A variety of ALS inhibitors are known and include, for example, sulfonylurea, imidazolinone, triazolopyrimidines, pryimidinyoxy(thio)benzoates, and/or sulfonylaminocarbonyltriazolinone herbicide. Additional ALS inhibitors are known and are disclosed elsewhere herein. It is known in the art that ALS mutations fall into different classes with regard to tolerance to sulfonylureas, imidazolinones, triazolopyrimidines, and pyrimidinyl(thio)benzoates, including mutations having the following characteristics: (1) broad tolerance to all four of these groups; (2) tolerance to imidazolinones and pyrimidinyl(thio)benzoates; (3) tolerance to sulfonylureas and triazolopyrimidines; and (4) tolerance to sulfonylureas and imidazolinones.

Various ALS inhibitor-tolerant polypeptides can be employed. In some embodiments, the ALS inhibitor-tolerant polynucleotides contain at least one nucleotide mutation resulting in one amino acid change in the ALS polypeptide. In specific embodiments, the change occurs in one of seven substantially conserved regions of acetolactate synthase. See, for example, Hattori et al. (1995) Molecular Genetics and Genomes 246:419-425; Lee et al. (1998) EMBO Journal 7:1241-1248; Mazur et al. (1989) Ann. Rev. Plant Phys. 40:441-470; and U.S. Pat. No. 5,605,011, each of which is incorporated by reference in their entirety. The ALS inhibitor-tolerant polypeptide can be encoded by, for example, the SuRA or SuRB locus of ALS. In specific embodiments, the ALS inhibitor-tolerant polypeptide comprises the C3 ALS mutant, the HRA ALS mutant, the S4 mutant or the S4/HRA mutant or any combination thereof. Different mutations in ALS are known to confer tolerance to different herbicides and groups (and/or subgroups) of herbicides; see, e.g., Tranel and Wright (2002) Weed Science 50:700-712. See also, U.S. Pat. Nos. 5,605,011, 5,378,824, 5,141,870, and 5,013,659, each of which is herein incorporated by reference in their entirety. See also, SEQ ID NO:12 comprising a soybean HRA sequence; SEQ ID NO:13 comprising a maize HRA sequence; SEQ ID NO:14 comprising an Arabidopsis HRA sequence; and SEQ ID NO:15 comprising an HRA sequence used in cotton. The HRA mutation in ALS finds particular use in one embodiment of the invention. The mutation results in the production of an acetolactate synthase polypeptide which is resistant to at least one ALS inhibitor chemistry in comparison to the wild-type protein. For example, a plant expressing an ALS inhibitor-tolerant polypeptide may be tolerant of a dose of sulfonylurea, imidazolinone, triazolopyrimidines, pryimidinyloxy(thio)benzoates, and/or sulfonylaminocarbonyltriazolinone herbicide. In some embodiments, an ALS inhibitor-tolerant polypeptide comprises a number of mutations. Additionally, plants having an ALS inhibitor polypeptide can be generated through the selection of naturally occurring mutations that impart tolerance to glyphosate.

In some embodiments, the ALS inhibitor-tolerant polypeptide confers tolerance to sulfonylurea and imidazolinone herbicides. Sulfonylurea and imidazolinone herbicides inhibit growth of higher plants by blocking acetolactate synthase (ALS), also known as, acetohydroxy acid synthase (AHAS). For example, plants containing particular mutations in ALS (e.g., the S4 and/or HRA mutations) are tolerant to sulfonylurea herbicides. The production of sulfonylurea-tolerant plants and imidazolinone-tolerant plants is described more fully in U.S. Pat. Nos. 5,605,011; 5,013,659; 5,141,870; 5,767,361; 5,731,180; 5,304,732; 4,761,373; 5,331,107; 5,928,937; and 5,378,824; and international publication WO 96/33270, which are incorporated herein by reference in their entireties for all purposes. In specific embodiments, the ALS inhibitor-tolerant polypeptide comprises a sulfonamide-tolerant acetolactate synthase (otherwise known as a sulfonamide-tolerant acetohydroxy acid synthase) or an imidazolinone-tolerant acetolactate synthase (otherwise known as an imidazolinone-tolerant acetohydroxy acid synthase).

Additional herbicides that the glyphosate tolerant plants of the invention can be tolerant to include, but are not limited to, an acetyl Co-A carboxylase inhibitor such as quizalofop-P-ethyl, a synthetic auxin such as quinclorac, a protoporphyrinogen oxidase (PPO) inhibitor herbicide (such as sulfentrazone) (see, U.S. Pat. Nos. 6,288,306 B1; 6,282,837 B1; and 5,767,373; and international publication WO 01/12825), a pigment synthesis inhibitor herbicide such as a hydroxyphenylpyruvate dioxygenase (HPPD) inhibitor (e.g., mesotrione or sulcotrione), a phosphinothricin acetyltransferase (PAT) or a phytoene desaturase inhibitor like diflufenican or pigment synthesis inhibitor.

In some embodiments, the compositions of the invention further comprise polypeptides conferring tolerance to herbicides which inhibit the enzyme glutamine synthase, such as phosphinothricin or glufosinate (e.g., the bar gene or pat gene). Glutamine synthetase (GS) appears to be an essential enzyme necessary for the development and life of most plant cells, and inhibitors of GS are toxic to plant cells. Glufosinate herbicides have been developed based on the toxic effect due to the inhibition of GS in plants. These herbicides are non-selective; that is, they inhibit growth of all the different species of plants present. The development of plants containing an exogenous phosphinothricin acetyltransferase is described in U.S. Pat. Nos. 5,969,213; 5,489,520; 5,550,318; 5,874,265; 5,919,675; 5,561,236; 5,648,477; 5,646,024; 6,177,616; and 5,879,903, which are incorporated herein by reference in their entireties for all purposes. Mutated phosphinothricin acetyltransferase having this activity are also disclosed.

In still other embodiments, the compositions of the invention further comprise polypeptides conferring tolerance to herbicides which inhibit protox (protoporphyrinogen oxidase). Protox is necessary for the production of chlorophyll, which is necessary for all plant survival. The protox enzyme serves as the target for a variety of herbicidal compounds. These herbicides also inhibit growth of all the different species of plants present. The development of plants containing altered protox activity which are resistant to these herbicides are described in U.S. Pat. Nos. 6,288,306; 6,282,837; and 5,767,373; and international publication WO 01/12825, which are incorporated herein by reference in their entireties for all purposes.

In still other embodiments, compositions may comprise polypeptides involving other modes of herbicide resistance. For example, hydroxyphenylpyruvatedioxygenases are enzymes that catalyze the reaction in which para-hydroxyphenylpyruvate (HPP) is transformed into homogentisate. Molecules which inhibit this enzyme and which bind to the enzyme in order to inhibit transformation of the HPP into homogentisate are useful as herbicides. Plants more resistant to certain herbicides are described in U.S. Pat. Nos. 6,245,968; 6,268,549; and 6,069,115; and international publication WO 99/23886, which are incorporated herein by reference in their entireties for all purposes. Mutated hydroxyphenylpyruvatedioxygenase having this activity are also disclosed.

In some embodiments, the polynucleotides conferring the glyphosate tolerance via two distinct modes of action are engineered into a molecular stack. In other embodiments, the molecular stack further comprises at least one additional polynucleotide that confers tolerance to any of the sequences encoding an additional trait of interest. In still other embodiments, the molecular stack comprises at least one sequence imparting tolerance to glyphosate and one sequence imparting tolerance to an ALS chemistry.

A trait, as used herein, refers to the phenotype derived from a particular sequence or groups of sequences. For example, herbicide-tolerance polynucleotides may be stacked with any other polynucleotides encoding polypeptides having pesticidal and/or insecticidal activity, such as Bacillus thuringiensis toxic proteins (described in U.S. Pat. Nos. 5,366,892; 5,747,450; 5,737,514; 5,723,756; 5,593,881; Geiser et al. (1986) Gene 48: 109; Lee et al. (2003) Appl. Environ. Microbiol. 69: 4648-4657 (Vip3A); Galitzky et al. (2001) Acta Crystallogr. D. Biol. Crystallogr. 57: 1101-1109 (Cry3Bb1); and Herman et al. (2004) J. Agric. Food Chem. 52: 2726-2734 (Cry1F)), lectins (Van Damme et al. (1994) Plant Mol. Biol. 24: 825, pentin (described in U.S. Pat. No. 5,981,722), and the like. The combinations generated can also include multiple copies of any one of the polynucleotides of interest.

Additional traits of interest include, but are not limited to, traits desirable for animal feed such as high oil content (e.g., U.S. Pat. No. 6,232,529); balanced amino acid content (e.g., hordothionins (U.S. Pat. Nos. 5,990,389; 5,885,801; 5,885,802; and 5,703,409; U.S. Pat. No. 5,850,016); barley high lysine (Williamson et al. (1987) Eur. J. Biochem. 165: 99-106; and WO 98/20122) and high methionine proteins (Pedersen et al. (1986) J. Biol. Chem. 261:6279; Kirihara et al. (1988) Gene 71:359; and Musumura et al. (1989) Plant Mol. Biol. 12:123)); increased digestibility (e.g., modified storage proteins (U.S. application Ser. No. 10/053,410, filed Nov. 7, 2001); and thioredoxins (U.S. application Ser. No. 10/005,429, filed Dec. 3, 2001)); the disclosures of which are herein incorporated by reference. Desired trait combinations also include low linolenic acid content; see, e.g., Dyer et al. (2002) Appl. Microbiol. Biotechnol. 59: 224-230) and high oleic acid content; see, e.g., Fernandez-Moya et al. (2005) J. Agric. Food Chem. 53: 5326-5330). Fumonisim detoxification genes (U.S. Pat. No. 5,792,931), avirulence and disease resistance genes (Jones et al. (1994) Science 266: 789; Martin et al. (1993) Science 262: 1432; Mindrinos et al. (1994) Cell 78: 1089), and traits desirable for processing or process products such as modified oils (e.g., fatty acid desaturase genes (U.S. Pat. No. 5,952,544; WO 94/11516)); modified starches (e.g., ADPG pyrophosphorylases (AGPase), starch synthases (SS), starch branching enzymes (SBE), and starch debranching enzymes (SDBE)); and polymers or bioplastics (e.g., U.S. Pat. No. 5,602,321; beta-ketothiolase, polyhydroxybutyrate synthase, and acetoacetyl-CoA reductase (Schubert et al. (1988) J. Bacteriol. 170:5837-5847) facilitate expression of polyhydroxyalkanoates (PHAs)); the disclosures of which are herein incorporated by reference. Male sterility (e.g., see U.S. Pat. No. 5,583,210), stalk strength, flowering time, or transformation technology traits such as cell cycle regulation or gene targeting (e.g., WO 99/61619, WO 00/17364, and WO 99/25821); the disclosures of which are herein incorporated by reference.

In another embodiment, the trait of interest can comprise the Rcg1 sequence or biologically active variant or fragment thereof. The Rcg1 sequence is an anthracnose stalk rot resistance gene in corn. See, for example, U.S. patent application Ser. No. 11/397,153, 11/397,275, and 11/397,247, each of which is herein incorporated by reference.

Additional traits of interest can include tolerances to nematodes, fungal pathogens, bacterial pathogens, insect pests, physiological growing conditions such as iron chlorosis deficiency and drought tolerance.

These stacked combinations can be created by any method including, but not limited to, breeding plants by any conventional or TopCross methodology, or genetic transformation. If the sequences are stacked by genetically transforming the plants, the polynucleotide sequences of interest can be combined at any time and in any order. For example, a transgenic plant comprising one or more desired traits can be used as the target to introduce further traits by subsequent transformation. The traits can be introduced simultaneously in a co-transformation protocol with the polynucleotides of interest provided by any combination of transformation cassettes. For example, if two sequences will be introduced, the two sequences can be contained in separate transformation cassettes (trans) or contained on the same transformation cassette (cis). Expression of the sequences can be driven by the same promoter or by different promoters. In certain cases, it may be desirable to introduce a transformation cassette that will suppress the expression of the polynucleotide of interest. This may be combined with any combination of other suppression cassettes or overexpression cassettes to generate the desired combination of traits in the plant. It is further recognized that polynucleotide sequences can be stacked at a desired genomic location using a site-specific recombination system. See, for example, WO99/25821, WO99/25854, WO99/25840, WO99/25855, and WO99/25853, all of which are herein incorporated by reference.

Various changes in phenotype are of interest including modifying the fatty acid composition in a plant, altering the amino acid content of a plant, altering a plant's pathogen defense mechanism, and the like. These results can be achieved by providing expression of heterologous products or increased expression of endogenous products in plants. Alternatively, the results can be achieved by providing for a reduction of expression of one or more endogenous products, particularly enzymes or cofactors in the plant. These changes result in a change in phenotype of the transformed plant.

e. Fragments and Variants of Sequences that Confer Herbicide Tolerance

Depending on the context, “fragment” refers to a portion of the polynucleotide or a portion of the amino acid sequence and hence protein encoded thereby. Fragments of a polynucleotide may encode protein fragments that retain the biological activity of the original protein and hence confer tolerance to a herbicide. Thus, fragments of a nucleotide sequence may range from at least about 20 nucleotides, about 50 nucleotides, about 100 nucleotides, and up to the full-length polynucleotide encoding a herbicide-tolerance polypeptide.

A fragment of a herbicide-tolerance polynucleotide that encodes a biologically active portion of a herbicide-tolerance polypeptide will encode at least 15, 25, 30, 50, 100, 150, 200, or 250 contiguous amino acids, or up to the total number of amino acids present in a full-length herbicide-tolerance polypeptide. A biologically active portion of a herbicide-tolerance polypeptide can be prepared by isolating a portion of a herbicide-tolerance polynucleotide, expressing the encoded portion of the herbicide-tolerance polypeptide (e.g., by recombinant expression in vitro), and assessing the activity of the encoded portion of the herbicide-tolerance polypeptide. Polynucleotides that are fragments of a herbicide-tolerance polynucleotide comprise at least 16, 20, 50, 75, 100, 150, 200, 250, 300, 350, 400, 450, 500, 550, 600, 650, 700, 800, 900, 1,000, 1,100, 1,200, 1,300, or 1,400 contiguous nucleotides, or up to the number of nucleotides present in a full-length herbicide-tolerance polynucleotide.

The term “variants” refers to substantially similar sequences. For polynucleotides, a variant comprises a polynucleotide having deletions (i.e., truncations) at the 5′ and/or 3′ end; deletion and/or addition of one or more nucleotides at one or more internal sites in the native polynucleotide; and/or substitution of one or more nucleotides at one or more sites in the native polynucleotide. As used herein, a “native” polynucleotide or polypeptide comprises a naturally-occurring nucleotide sequence or amino acid sequence, respectively. For polynucleotides, conservative variants include those sequences that, because of the degeneracy of the genetic code, encode the amino acid sequence of a herbicide-tolerance polypeptide. Naturally occurring allelic variants such as these can be identified with the use of well-known molecular biology techniques, as, for example, with polymerase chain reaction (PCR) and hybridization techniques. Variant polynucleotides also include synthetically derived polynucleotides, such as those generated, for example, by using site-directed mutagenesis or “shuffling.” Generally, variants of a particular polynucleotide have at least about 40%, 45%, 50%, 55%, 60%, 65%, 70%, 75%, 80%, 85%, 90%, 91%, 92%, 93%, 94%, 95%, 96%, 97%, 98%, 99% or more sequence identity to that particular polynucleotide as determined by sequence alignment programs and parameters as described elsewhere herein.

Variants of a particular polynucleotide (i.e., the reference polynucleotide) can also be evaluated by comparison of the percent sequence identity between the polypeptide encoded by a variant polynucleotide and the polypeptide encoded by the reference polynucleotide. Percent sequence identity between any two polypeptides can be calculated using sequence alignment programs and parameters described elsewhere herein. Where any given pair of polynucleotides of the invention is evaluated by comparison of the percent sequence identity shared by the two polypeptides they encode, the percent sequence identity between the two encoded polypeptides is at least about 40%, 45%, 50%, 55%, 60%, 65%, 70%, 75%, 80%, 85%, 90%, 91%, 92%, 93%, 94%, 95%, 96%, 97%, 98%, 99% or more sequence identity.

“Variant” protein is intended to mean a protein derived from a native and/or original protein by deletion (so-called truncation) of one or more amino acids at the N-terminal and/or C-terminal end of the protein; deletion and/or addition of one or more amino acids at one or more internal sites in the protein; or substitution of one or more amino acids at one or more sites in the protein. Variant proteins encompassed by the present invention are biologically active, that is they continue to possess the desired herbicide-tolerance activity as described herein. Biologically active variants of a herbicide-tolerance polypeptide of the invention will have at least about 40%, 45%, 50%, 55%, 60%, 65%, 70%, 75%, 80%, 85%, 90%, 91%, 92%, 93%, 94%, 95%, 96%, 97%, 98%, 99% or more sequence identity to the amino acid sequence for the native protein as determined by sequence alignment programs and parameters described elsewhere herein. A biologically active variant of a herbicide-tolerance polypeptide may differ from that polypeptide by as few as 1-15 amino acid residues, as few as 1-10, such as 6-10, as few as 5, as few as 4, 3, 2, or even 1 amino acid residue. Variant herbicide-tolerance polypeptides, as well as polynucleotides encoding these variants, are known in the art.

Herbicide-tolerance polypeptides may be altered in various ways including amino acid substitutions, deletions, truncations, and insertions. Methods for such manipulations are generally known in the art. For example, amino acid sequence variants and fragments of herbicide-tolerance polypeptides can be prepared by mutations in the encoding polynucleotide. Methods for mutagenesis and polynucleotide alterations are well known in the art. See, for example, Kunkel (1985) Proc. Natl. Acad. Sci. USA 82: 488-492; Kunkel et al. (1987) Methods in Enzymol. 154: 367-382; U.S. Pat. No. 4,873,192; Walker and Gaastra, eds. (1983) Techniques in Molecular Biology (MacMillan Publishing Company, New York) and the references cited therein. Guidance as to amino acid substitutions that do not affect biological activity of the protein of interest may be found in the model of Dayhoff et al. (1978) Atlas of Protein Sequence and Structure (Natl. Biomed. Res. Found., Washington, D.C.), herein incorporated by reference. Conservative substitutions, such as exchanging one amino acid with another having similar properties, may be made. One skilled in the art will appreciate that the activity of a herbicide-tolerance polypeptide can be evaluated by routine screening assays. That is, the activity can be evaluated by determining whether a transgenic plant has an increased tolerance to a herbicide, for example, as illustrated in working Example 1, or with an in vitro assay, such as the production of N-acetylglyphosphate from glyphosate by a GLYAT polypeptide (see, e.g., WO 02/36782).

Variant polynucleotides and polypeptides also encompass sequences and proteins derived from a mutagenic and recombinogenic procedure such as DNA shuffling. With such a procedure, one or more different herbicide-tolerance polypeptide coding sequences can be manipulated to create a new herbicide-tolerance polypeptide possessing the desired properties. In this manner, libraries of recombinant polynucleotides are generated from a population of related sequence polynucleotides comprising sequence regions that have substantial sequence identity and can be homologously recombined in vitro or in vivo. For example, using this approach, sequence motifs encoding a domain of interest may be shuffled between a herbicide-tolerance polypeptide and other known genes to obtain a new gene coding for a protein with an improved property of interest, such as an increased Kₘ in the case of an enzyme. Strategies for such DNA shuffling are known in the art. See, for example, Stemmer (1994) Proc. Natl. Acad. Sci. USA 91: 10747-10751; Stemmer (1994) Nature 370: 389-391; Crameri et al. (1997) Nature Biotech. 15: 436-438; Moore et al. (1997) J. Mol. Biol. 272: 336-347; Zhang et al. (1997) Proc. Natl. Acad. Sci. USA 94: 4504-4509; Crameri et al. (1998) Nature 391: 288-291; and U.S. Pat. Nos. 5,605,793 and 5,837,458.

The following terms are used to describe the sequence relationships between two or more polynucleotides or polypeptides: (a) “reference sequence”, (b) “comparison window”, (c) “sequence identity”, and, (d) “percentage of sequence identity.”

(a) As used herein, “reference sequence” is a defined sequence used as a basis for sequence comparison. A reference sequence may be a subset or the entirety of a specified sequence; for example, as a segment of a full-length cDNA or gene sequence, or the complete cDNA or gene sequence.

(b) As used herein, “comparison window” makes reference to a contiguous and specified segment of a polynucleotide sequence, wherein the polynucleotide sequence in the comparison window may comprise additions or deletions (i.e., gaps) compared to the reference sequence (which does not comprise additions or deletions) for optimal alignment of the two polynucleotides. Generally, the comparison window is at least 20 contiguous nucleotides in length, and optionally can be 30, 40, 50, 100, or longer. Those of skill in the art understand that to avoid a high similarity to a reference sequence due to inclusion of gaps in the polynucleotide sequence a gap penalty is typically introduced and is subtracted from the number of matches.

Methods of alignment of sequences for comparison are well known in the art. Thus, the determination of percent sequence identity between any two sequences can be accomplished using a mathematical algorithm. Non-limiting examples of such mathematical algorithms are the algorithm of Myers and Miller (1988) CABIOS 4: 11-17; the local alignment algorithm of Smith et al. (1981) Adv. Appl. Math. 2:482; the global alignment algorithm of Needleman and Wunsch (1970) J. Mol. Biol. 48: 443-453; the search-for-local alignment method of Pearson and Lipman (1988) Proc. Natl. Acad. Sci. 85: 2444-2448; the algorithm of Karlin and Altschul (1990) Proc. Natl. Acad. Sci. USA 87: 2264-2268, modified as in Karlin and Altschul (1993) Proc. Natl. Acad. Sci. USA 90: 5873-5877.

Computer implementations of these mathematical algorithms can be utilized for comparison of sequences to determine sequence identity. Such implementations include, but are not limited to: CLUSTAL in the PC/Gene program (available from Intelligenetics, Mountain View, Calif.); the ALIGN program (Version 2.0) and GAP, BESTFIT, BLAST, FASTA, and TFASTA in the GCG Wisconsin Genetics Software Package, Version 10 (available from Accelrys Inc., 9685 Scranton Road, San Diego, Calif., USA). Alignments using these programs can be performed using the default parameters. The CLUSTAL program is well described by Higgins et al. (1988) Gene 73: 237-244 (1988); Higgins et al. (1989) CABIOS 5: 151-153; Corpet et al. (1988) Nucleic Acids Res. 16:10881-90; Huang et al. (1992) CABIOS 8: 155-65; and Pearson et al. (1994) Meth. Mol. Biol. 24: 307-331. The ALIGN program is based on the algorithm of Myers and Miller (1988) supra. A PAM120 weight residue table, a gap length penalty of 12, and a gap penalty of 4 can be used with the ALIGN program when comparing amino acid sequences. The BLAST programs of Altschul et al (1990) J. Mol. Biol. 215:403 are based on the algorithm of Karlin and Altschul (1990) supra. BLAST nucleotide searches can be performed with the BLASTN program, score=100, wordlength=12, to obtain nucleotide sequences homologous to a nucleotide sequence encoding a protein of the invention. BLAST protein searches can be performed with the BLASTX program, score=50, wordlength=3, to obtain amino acid sequences homologous to a protein or polypeptide of the invention. To obtain gapped alignments for comparison purposes, Gapped BLAST (in BLAST 2.0) can be utilized as described in Altschul et al. (1997) Nucleic Acids Res. 25:3389. Alternatively, PSI-BLAST (in BLAST 2.0) can be used to perform an iterated search that detects distant relationships between molecules. See Altschul et al. (1997) supra. When utilizing BLAST, Gapped BLAST, PSI-BLAST, the default parameters of the respective programs (e.g., BLASTN for nucleotide sequences, BLASTX for proteins) can be used. BLAST software is publicly available on the NCBI website. Alignment may also be performed manually by inspection.

Unless otherwise stated, sequence identity/similarity values provided herein refer to the value obtained using GAP Version 10 using the following parameters: % identity and % similarity for a nucleotide sequence using GAP Weight of 50 and Length Weight of 3, and the nwsgapdna.cmp scoring matrix; % identity and % similarity for an amino acid sequence using GAP Weight of 8 and Length Weight of 2, and the BLOSUM62 scoring matrix; or any equivalent program thereof. By “equivalent program” is intended any sequence comparison program that, for any two sequences in question, generates an alignment having identical nucleotide or amino acid residue matches and an identical percent sequence identity when compared to the corresponding alignment generated by GAP Version 10.

GAP uses the algorithm of Needleman and Wunsch (1970) J. Mol. Biol. 48: 443-453, to find the alignment of two complete sequences that maximizes the number of matches and minimizes the number of gaps. GAP considers all possible alignments and gap positions and creates the alignment with the largest number of matched bases and the fewest gaps. It allows for the provision of a gap creation penalty and a gap extension penalty in units of matched bases. GAP must make a profit of gap creation penalty number of matches for each gap it inserts. If a gap extension penalty greater than zero is chosen, GAP must, in addition, make a profit for each gap inserted of the length of the gap times the gap extension penalty. Default gap creation penalty values and gap extension penalty values in Version 10 of the GCG Wisconsin Genetics Software Package for protein sequences are 8 and 2, respectively. For nucleotide sequences the default gap creation penalty is 50 while the default gap extension penalty is 3. The gap creation and gap extension penalties can be expressed as an integer selected from the group of integers consisting of from 0 to 200. Thus, for example, the gap creation and gap extension penalties can be 0, 1, 2, 3, 4, 5, 6, 7, 8, 9, 10, 15, 20, 25, 30, 35, 40, 45, 50, 55, 60, 65 or greater.

GAP presents one member of the family of best alignments. There may be many members of this family, but no other member has a better quality. GAP displays four figures of merit for alignments: Quality, Ratio, Identity, and Similarity. The Quality is the metric maximized in order to align the sequences. Ratio is the quality divided by the number of bases in the shorter segment. Percent Identity is the percent of the symbols that actually match. Percent Similarity is the percent of the symbols that are similar. Symbols that are across from gaps are ignored. A similarity is scored when the scoring matrix value for a pair of symbols is greater than or equal to 0.50, the similarity threshold. The scoring matrix used in Version 10 of the GCG Wisconsin Genetics Software Package is BLOSUM62 (see Henikoff and Henikoff (1989) Proc. Natl. Acad. Sci. USA 89: 10915).

(c) As used herein, “sequence identity” or “identity” in the context of two polynucleotides or polypeptide sequences makes reference to the residues in the two sequences that are the same when aligned for maximum correspondence over a specified comparison window. When percentage of sequence identity is used in reference to proteins it is recognized that residue positions which are not identical often differ by conservative amino acid substitutions, where amino acid residues are substituted for other amino acid residues with similar chemical properties (e.g., charge or hydrophobicity) and therefore do not change the functional properties of the molecule. When sequences differ in conservative substitutions, the percent sequence identity may be adjusted upwards to correct for the conservative nature of the substitution. Sequences that differ by such conservative substitutions are said to have “sequence similarity” or “similarity”. Means for making this adjustment are well known to those of skill in the art. Typically this involves scoring a conservative substitution as a partial rather than a full mismatch, thereby increasing the percentage sequence identity. Thus, for example, where an identical amino acid is given a score of 1 and a non-conservative substitution is given a score of zero, a conservative substitution is given a score between zero and 1. The scoring of conservative substitutions is calculated, e.g., as implemented in the program PC/GENE (Intelligenetics, Mountain View, Calif.).

(d) As used herein, “percentage of sequence identity” means the value determined by comparing two optimally aligned sequences over a comparison window, wherein the portion of the polynucleotide sequence in the comparison window may comprise additions or deletions (i.e., gaps) as compared to the reference sequence (which does not comprise additions or deletions) for optimal alignment of the two sequences. The percentage is calculated by determining the number of positions at which the identical nucleic acid base or amino acid residue occurs in both sequences to yield the number of matched positions, dividing the number of matched positions by the total number of positions in the window of comparison, and multiplying the result by 100 to yield the percentage of sequence identity.

The use of the term “polynucleotide” is not intended to be limited to polynucleotides comprising DNA. Those of ordinary skill in the art will recognize that polynucleotides can comprise ribonucleotides and combinations of ribonucleotides and deoxyribonucleotides. Such deoxyribonucleotides and ribonucleotides include both naturally occurring molecules and synthetic analogues. Thus, polynucleotides also encompass all forms of sequences including, but not limited to, single-stranded forms, double-stranded forms, hairpins, stem-and-loop structures, and the like.

f. Plants

As used herein, the term “plant” includes plant cells, plant protoplasts, plant cell tissue cultures from which plants can be regenerated, plant calli, plant clumps, explants, and plant cells that are intact in plants or parts of plants such as embryos, pollen, ovules, seeds, leaves, flowers, branches, fruit, kernels, ears, cobs, husks, stalks, roots, root tips, anthers, and the like. Grain is intended to mean the mature seed produced by commercial growers for purposes other than growing or reproducing the species. Progeny, variants, and mutants of the regenerated plants are also included within the scope of the invention, provided that these parts comprise the introduced polynucleotides. Thus, the invention provides transgenic seeds produced by the plants of the invention.

The present invention may be used for transformation of any plant species, including, but not limited to, monocots and dicots. Examples of plant species of interest include, but are not limited to, corn (Zea mays, also referred to herein as “maize”), Brassica spp. (e.g., B. napus, B. rapa, B. juncea), particularly those Brassica species useful as sources of seed oil (also referred to as “canola”), flax (Linum spp.), alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), canola, coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oats, barley, vegetables, fruits, ornamentals (flowers), sugar cane, conifers, and Arabidopsis species.

Vegetables include tomatoes (Lycopersicon esculentum), lettuce (e.g., Lactuca sativa), green beans (Phaseolus vulgaris), lima beans (Phaseolus limensis), peas (Lathyrus spp.), and members of the genus Cucumis such as cucumber (C. sativus), cantaloupe (C. cantalupensis), and musk melon (C. melo). Ornamentals include azalea (Rhododendron spp.), hydrangea (Macrophylla hydrangea), hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pulcherrima), and chrysanthemum.

Any tree can also be employed. Conifers that may be employed in practicing the present invention include, for example, pines such as loblolly pine (Pinus taeda), slash pine (Pinus elliotii), ponderosa pine (Pin us ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis). Hardwood trees can also be employed including ash, aspen, beech, basswood, birch, black cherry, black walnut, buckeye, American chestnut, cottonwood, dogwood, elm, hackberry, hickory, holly, locust, magnolia, maple, oak, poplar, red alder, redbud, royal paulownia, sassafras, sweetgum, sycamore, tupelo, willow, yellow-poplar.

In specific embodiments, plants of the present invention are crop plants (for example, corn (also referred to as “maize”), alfalfa, sunflower, Brassica, soybean, cotton, canola, safflower, peanut, sorghum, wheat, millet, tobacco, etc.).

Other plants of interest include grain plants that provide seeds of interest, oil-seed plants, and leguminous plants. Seeds of interest include grain seeds, such as corn, wheat, barley, canola, rice, sorghum, rye, etc. Oil-seed plants include cotton, soybean, safflower, sunflower, Brassica, maize, alfalfa, palm, canola, coconut, etc. Leguminous plants include beans and peas. Beans include guar, locust bean, fenugreek, soybean, garden beans, cowpea, mungbean, lima bean, fava bean, lentils, chickpea, etc.

Other plants of interest include Turfgrasses such as, for example, turfgrasses from the genus Poa, Agrostis, Festuca, Lolium, and Zoysia. Additional turfgrasses can come from the subfamily Panicoideae. Turfgrasses can further include, but are not limited to, Blue gramma (Bouteloua gracilis (H.B.K.) Lag. Ex Griffiths); Buffalograss (Buchloe dactyloids (Nutt.) Engelm.); Slender creeping red fescue (Festuca rubra ssp. Litoralis); Red fescue (Festuca rubra); Colonial bentgrass (Agrostis tenuis Sibth.); Creeping bentgrass (Agrostis palustris Huds.); Fairway wheatgrass (Agropyron cristatum (L.) Gaertn.); Hard fescue (Festuca longifolia Thuill.); Kentucky bluegrass (Poa pratensis L.); Perennial ryegrass (Lolium perenne L.); Rough bluegrass (Poa trivialis L.); Sideoats grama (Bouteloua curtipendula Michx. Torr.); Smooth bromegrass (Bromus inermis Leyss.); Tall fescue (Festuca arundinacea Schreb.); Annual bluegrass (Poa annua L.); Annual ryegrass (Lolium multiflorum Lam.); Redtop (Agrostis alba L.); Japanese lawn grass (Zoysia japonica); bermudagrass (Cynodon dactylon; Cynodon spp. L.C. Rich; Cynodon transvaalensis); Seashore paspalum (Paspalum vaginatum Swartz); Zoysiagrass (Zoysia spp. Willd; Zoysia japonica and Z. matrella var. matrella); Bahiagrass (Paspalum notatum Flugge); Carpetgrass (Axonopus affinis Chase); Centipedegrass (Eremochloa ophiuroides Munro Hack.); Kikuyugrass (Pennisetum clandesinum Hochst Ex Chiov); Browntop bent (Agrostis tenuis also known as A. capillaris); Velvet bent (Agrostis canina); Perennial ryegrass (Lolium perenne); and, St. Augustinegrass (Stenotaphrum secundatum Walt. Kuntze). Additional grasses of interest include switchgrass (Panicum virGLYATum).

### II. Polynucleotide Constructs

In specific embodiments, one or more of the glyphosate tolerant polynucleotides employed in the methods and compositions can be provided in an expression cassette for expression in the plant. The cassette will include 5′ and 3′ regulatory sequences operably linked to a herbicide-tolerance polynucleotide. “Operably linked” is intended to mean a functional linkage between two or more elements. For example, an operable linkage between a polynucleotide of interest and a regulatory sequence (e.g., a promoter) is functional link that allows for expression of the polynucleotide of interest. Operably linked elements may be contiguous or non-contiguous. When used to refer to the joining of two protein coding regions, by “operably linked” is intended that the coding regions are in the same reading frame. When used to refer to the effect of an enhancer, “operably linked” indicates that the enhancer increases the expression of a particular polynucleotide or polynucleotides of interest. Where the polynucleotide or polynucleotides of interest encode a polypeptide, the encoded polypeptide is produced at a higher level.

The cassette may additionally contain at least one additional gene to be cotransformed into the organism. Alternatively, the additional gene(s) can be provided on multiple expression cassettes. Such an expression cassette is provided with a plurality of restriction sites and/or recombination sites for insertion of the herbicide-tolerance polynucleotide to be under the transcriptional regulation of the regulatory regions. The expression cassette may additionally contain other genes, including other selectable marker genes. Where a cassette contains more than one polynucleotide, the polynucleotides in the cassette may be transcribed in the same direction or in different directions (also called “divergent” transcription).

The regulatory regions (i.e., promoters, transcriptional regulatory regions, and translational termination regions) and/or the herbicide tolerance polynucleotide may be native (i.e., analogous) to the host cell or to each other. Alternatively, the regulatory regions and/or the herbicide tolerance polynucleotide may be heterologous to the host cell or to each other. As used herein, “heterologous” in reference to a sequence is a sequence that originates from a foreign species, or, if from the same species, is substantially modified from its native form in composition and/or genomic locus by deliberate human intervention. For example, a promoter operably linked to a heterologous polynucleotide is from a species different from the species from which the polynucleotide was derived, or, if from the same (i.e., analogous) species, one or both are substantially modified from their original form and/or genomic locus, or the promoter is not the native promoter for the operably linked polynucleotide.

While it may be optimal to express polynucleotides using heterologous promoters, native promoter sequences may be used. Such constructs can change expression levels and/or expression patterns of the encoded polypeptide in the plant or plant cell. Expression levels and/or expression patterns of the encoded polypeptide may also be changed as a result of an additional regulatory element that is part of the construct, such as, for example, an enhancer. Thus, the phenotype of the plant or cell can be altered even though a native promoter is used.

The termination region may be native with the transcriptional initiation region, may be native with the operably linked herbicide-tolerance polynucleotide of interest, may be native with the plant host, or may be derived from another source (i.e., foreign or heterologous) to the promoter, the herbicide-tolerance polynucleotide of interest, the plant host, or any combination thereof. Convenient termination regions are available from the Ti-plasmid of A. tumefaciens, such as the octopine synthase and nopaline synthase termination regions, or can be obtained from plant genes such as the Solanum tuberosum proteinase inhibitor II gene. See also Guerineau et al. (1991) Mol. Gen. Genet. 262: 141-144; Proudfoot (1991) Cell 64: 671-674; Sanfacon et al. (1991) Genes Dev. 5: 141-149; Mogen et al. (1990) Plant Cell 2: 1261-1272; Munroe et al. (1990) Gene 91: 151-158; Ballas et al. (1989) Nucleic Acids Res. 17: 7891-7903; and Joshi et al. (1987) Nucleic Acids Res. 15: 9627-9639.

A number of promoters can be used in the practice of the invention, including the native promoter of the polynucleotide sequence of interest. The promoters can be selected based on the desired outcome. The polynucleotides of interest can be combined with constitutive, tissue-preferred, or other promoters for expression in plants.

Such constitutive promoters include, for example, the core promoter of the Rsyn7 promoter and other constitutive promoters disclosed in WO 99/43838 and U.S. Pat. No. 6,072,050; the core CaMV 35S promoter (Odell et al. (1985) Nature 313: 810-812); rice actin (McElroy et al. (1990) Plant Cell 2: 163-171); the maize actin promoter; the ubiquitin promoter (see, e.g., Christensen et al. (1989) Plant Mol. Biol. 12: 619-632; Christensen et al. (1992) Plant Mol. Biol. 18: 675-689; Callis et al. (1995) Genetics 139: 921-39); pEMU (Last et al. (1991) Theor. Appl. Genet. 81: 581-588); MAS (Velten et al. (1984) EMBO J. 3: 2723-2730); ALS promoter (U.S. Pat. No. 5,659,026), and the like. Other constitutive promoters include, for example, those described in U.S. Pat. Nos. 5,608,149; 5,608,144; 5,604,121; 5,569,597; 5,466,785; 5,399,680; 5,268,463; 5,608,142; and 6,177,611. Some promoters show improved expression when they are used in conjunction with a native 5′ untranslated region and/or other elements such as, for example, an intron. For example, the maize ubiquitin promoter is often placed upstream of a polynucleotide of interest along with at least a portion of the 5′ untranslated region of the ubiquitin gene, including the first intron of the maize ubiquitin gene.

Chemical-regulated promoters can be used to modulate the expression of a gene in a plant through the application of an exogenous chemical regulator. Depending upon the objective, the promoter may be a chemical-inducible promoter for which application of the chemical induces gene expression or the promoter may be a chemical-repressible promoter for which application of the chemical represses gene expression. Chemical-inducible promoters are known in the art and include, but are not limited to, the maize In2-2 promoter, which is activated by benzenesulfonamide herbicide safeners, the maize GST promoter, which is activated by hydrophobic electrophilic compounds that are used as pre-emergent herbicides, and the tobacco PR-1a promoter, which is activated by salicylic acid. Other chemical-regulated promoters of interest include steroid-responsive promoters (see, for example, the glucocorticoid-inducible promoter in Schena et al. (1991) Proc. Natl. Acad. Sci. USA 88: 10421-10425 and McNellis et al. (1998) Plant J. 14(2): 247-257) and tetracycline-inducible and tetracycline-repressible promoters (see, for example, Gatz et al. (1991) Mol. Gen. Genet. 227: 229-237, and U.S. Pat. Nos. 5,814,618 and 5,789,156), herein incorporated by reference.

Tissue-preferred promoters can be utilized to target enhanced herbicide-tolerance polypeptide expression within a particular plant tissue. Tissue-preferred promoters include Yamamoto et al. (1997) Plant J. 12(2): 255-265; Kawamata et al. (1997) Plant Cell Physiol. 38(7): 792-803; Hansen et al. (1997) Mol. Gen. Genet. 254(3): 337-343; Russell et al. (1997) Transgenic Res. 6(2): 157-168; Rinehart et al. (1996) Plant Physiol. 112(3): 1331-1341; Van Camp et al. (1996) Plant Physiol. 112(2): 525-535; Canevascini et al. (1996) Plant Physiol. 112(2): 513-524; Yamamoto et al. (1994) Plant Cell Physiol. 35(5): 773-778; Lam (1994) Results Probl. Cell Differ. 20: 181-196; Orozco et al. (1993) Plant Mol. Biol. 23(6): 1129-1138; Matsuoka et al. (1993) Proc Natl. Acad. Sci. USA 90(20): 9586-9590; and Guevara-Garcia et al. (1993) Plant J. 4(3): 495-505. Such promoters can be modified, if necessary, for weak expression.

Leaf-preferred promoters are known in the art. See, for example, Yamamoto et al. (1997) Plant J. 12(2): 255-265; Kwon et al. (1994) Plant Physiol. 105: 357-67; Yamamoto et al. (1994) Plant Cell Physiol. 35(5): 773-778; Gotor et al. (1993) Plant J. 3: 509-18; Orozco et al. (1993) Plant Mol. Biol. 23(6): 1129-1138; and Matsuoka et al. (1993) Proc. Natl. Acad. Sci. USA 90(20): 9586-9590.

Root-preferred promoters are known and can be selected from the many available from the literature or isolated de novo from various compatible species. See, for example, Hire et al. (1992) Plant Mol. Biol. 20(2): 207-218 (soybean root-specific glutamine synthetase gene); Keller and Baumgartner (1991) Plant Cell 3(10): 1051-1061 (root-specific control element in the GRP 1. 8 gene of French bean); Sanger et al. (1990) Plant Mol. Biol. 14(3): 433-443 (root-specific promoter of the mannopine synthase (MAS) gene of Agrobacterium tumefaciens); and Miao et al. (1991) Plant Cell 3(1): 11-22 (full-length cDNA clone encoding cytosolic glutamine synthetase (GS), which is expressed in roots and root nodules of soybean). See also Bogusz et al. (1990) Plant Cell 2(7): 633-641, where two root-specific promoters isolated from hemoglobin genes from the nitrogen-fixing nonlegume Parasponia andersonii and the related non-nitrogen-fixing nonlegume Trema tomentosa are described. The promoters of these genes were linked to a β-glucuronidase reporter gene and introduced into both the nonlegume Nicotiana tabacum and the legume Lotus corniculatus, and in both instances root-specific promoter activity was preserved. Leach and Aoyagi (1991) describe their analysis of the promoters of the highly expressed rolC and rolD root-inducing genes of Agrobacterium rhizogenes (see Plant Science (Limerick) 79(1): 69-76). They concluded that enhancer and tissue-preferred DNA determinants are dissociated in those promoters. Teeri et al. (1989) used gene fusion to lacZ to show that the Agrobacterium T-DNA gene encoding octopine synthase is especially active in the epidermis of the root tip and that the TR2′ gene is root specific in the intact plant and stimulated by wounding in leaf tissue, an especially desirable combination of characteristics for use with an insecticidal or larvicidal gene (see EMBO J. 8(2): 343-350). The TR1′ gene, fused to nptII (neomycin phosphotransferase II) showed similar characteristics. Additional root-preferred promoters include the VfENOD-GRP3 gene promoter (Kuster et al. (1995) Plant Mol. Biol. 29(4): 759-772); and rolB promoter (Capana et al. (1994) Plant Mol. Biol. 25(4): 681-691. See also U.S. Pat. Nos. 5,837,876; 5,750,386; 5,633,363; 5,459,252; 5,401,836; 5,110,732; and 5,023,179.

“Seed-preferred” promoters include both “seed-specific” promoters (those promoters active during seed development such as promoters of seed storage proteins) as well as “seed-germinating” promoters (those promoters active during seed germination). See Thompson et al. (1989) BioEssays 10: 108, herein incorporated by reference. Such seed-preferred promoters include, but are not limited to, Cim1 (cytokinin-induced message); cZ19B1 (maize 19 kDa zein); milps (myo-inositol-1-phosphate synthase) (see WO 00/11177 and U.S. Pat. No. 6,225,529; herein incorporated by reference). Gamma-zein is an endosperm-specific promoter. Globulin 1 (Glb-1) is a representative embryo-specific promoter. For dicots, seed-specific promoters include, but are not limited to, bean β-phaseolin, napin, β-conglycinin, soybean lectin, cruciferin, and the like. For monocots, seed-specific promoters include, but are not limited to, maize 15 kDa zein, 22 kDa zein, 27 kDa zein, gamma-zein, waxy, shrunken 1, shrunken 2, Globulin 1, etc. See also WO 00/12733, where seed-preferred promoters from end1 and end2 genes are disclosed; herein incorporated by reference.

Additional promoters of interest include the SCP1 promoter (U.S. Pat. No. 6,072,050), the H2B promoter (U.S. Pat. No. 6,177,611) and the SAMS promoter (US20030226166 and biologically active variants and fragments thereof); each of which is herein incorporated by reference. In addition, as discussed elsewhere herein, various enhancers can be used with these promoters including, for example, the ubiquitin intron (i.e, the maize ubiquitin intron 1 (see, for example, NCBI sequence S94464), the omega enhancer or the omega prime enhancer (Gallie et al. (1989) Molecular Biology of RNA ed. Cech (Liss, New York) 237-256 and Gallie et al. Gene (1987) 60:217-25), or the 35S enhancer; each of which is incorporated by reference.

The expression cassette can also comprise a selectable marker gene for the selection of transformed cells. Selectable marker genes are utilized for the selection of transformed cells or tissues. Marker genes include genes encoding antibiotic resistance, such as those encoding neomycin phosphotransferase II (NEO) and hygromycin phosphotransferase (HPT), as well as genes conferring resistance to herbicidal compounds, such as glufosinate ammonium, bromoxynil, imidazolinones, and 2,4-dichlorophenoxyacetate (2,4-D). Additional selectable markers include phenotypic markers such as β-galactosidase and fluorescent proteins such as green fluorescent protein (GFP) (Su et al. (2004) Biotechnol Bioeng 85: 610-9 and Fetter et al. (2004) Plant Cell 16: 215-28), cyan florescent protein (CYP) (Bolte et al. (2004) J. Cell Science 117: 943-54 and Kato et al. (2002) Plant Physiol 129: 913-42), and yellow fluorescent protein (PhiYFP from Evrogen, see, Bolte et al. (2004) J. Cell Science 117: 943-54). For additional selectable markers, see generally, Yarranton (1992) Curr. Opin. Biotech. 3: 506-511; Christopherson et al. (1992) Proc. Natl. Acad. Sci. USA 89: 6314-6318; Yao et al. (1992) Cell 71: 63-72; Reznikoff (1992) Mol. Microbiol. 6: 2419-2422; Barkley et al. (1980) in The Operon, pp. 177-220; Hu et al. (1987) Cell 48: 555-566; Brown et al. (1987) Cell 49: 603-612; Figge et al. (1988) Cell 52: 713-722; Deuschle et al. (1989) Proc. Natl. Acad. Aci. USA 86: 5400-5404; Fuerst et al. (1989) Proc. Natl. Acad. Sci. USA 86: 2549-2553; Deuschle et al. (1990) Science 248: 480-483; Gossen (1993) Ph.D. Thesis, University of Heidelberg; Reines et al. (1993) Proc. Natl. Acad. Sci. USA 90: 1917-1921; Labow et al. (1990) Mol. Cell. Biol. 10: 3343-3356; Zambretti et al. (1992) Proc. Natl. Acad. Sci. USA 89: 3952-3956; Baim et al. (1991) Proc. Natl. Acad. Sci. USA 88: 5072-5076; Wyborski et al. (1991) Nucleic Acids Res. 19: 4647-4653; Hillenand-Wissman (1989) Topics Mol. Struc. Biol. 10: 143-162; Degenkolb et al. (1991) Antimicrob. Agents Chemother. 35: 1591-1595; Kleinschnidt et al. (1988) Biochemistry 27: 1094-1104; Bonin (1993) Ph.D. Thesis, University of Heidelberg; Gossen et al. (1992) Proc. Natl. Acad. Sci. USA 89: 5547-5551; Oliva et al. (1992) Antimicrob. Agents Chemother. 36: 913-919; Hlavka et al. (1985) Handbook of Experimental Pharmacology, Vol. 78 (Springer-Verlag, Berlin); Gill et al. (1988) Nature 334: 721-724. Such disclosures are herein incorporated by reference. The above list of selectable marker genes is not meant to be limiting.

Methods are known in the art of increasing the expression level of a polypeptide of the invention in a plant or plant cell, for example, by inserting into the polypeptide coding sequence one or two G/C-rich codons (such as GCG or GCT) immediately adjacent to and downstream of the initiating methionine ATG codon. Where appropriate, the polynucleotides may be optimized for increased expression in the transformed plant. That is, the polynucleotides can be synthesized substituting in the polypeptide coding sequence one or more codons which are less frequently utilized in plants for codons encoding the same amino acid(s) which are more frequently utilized in plants, and introducing the modified coding sequence into a plant or plant cell and expressing the modified coding sequence. See, for example, Campbell and Gowri (1990) Plant Physiol. 92: 1-11 for a discussion of host-preferred codon usage. Methods are available in the art for synthesizing plant-preferred genes. See, for example, U.S. Pat. Nos. 5,380,831, and 5,436,391, and Murray et al. (1989) Nucleic Acids Res. 17: 477-498, herein incorporated by reference. Embodiments comprising such modifications are also a feature of the invention.

Additional sequence modifications are known to enhance gene expression in a cellular host. These include elimination of sequences encoding spurious polyadenylation signals, exon-intron splice site signals, transposon-like repeats, and other such well-characterized sequences that may be deleterious to gene expression. The G-C content of the sequence may be adjusted to levels average for a given cellular host, as calculated by reference to known genes expressed in the host cell. When possible, the sequence is modified to avoid predicted hairpin secondary mRNA structures. “Enhancers” such as the CaMV 35S enhancer may also be used (see, e.g., Benfey et al. (1990) EMBO J. 9: 1685-96), or other enhancers may be used. See, for example, US Application Publications 2007/0061917 and 2007/0130641, both of which are herein incorporated by reference in its entirety. The term “promoter” is intended to mean a regulatory region of DNA comprising a transcriptional initiation region, which in some embodiments, comprises a TATA box capable of directing RNA polymerase II to initiate RNA synthesis at the appropriate transcription initiation site for a particular coding sequence. The promoter can further be operably linked to additional regulatory elements that influence transcription, including, but not limited to, introns, 5′ untranslated regions, and enhancer elements. As used herein, an “enhancer sequence,” “enhancer domain,” “enhancer element,” or “enhancer,” when operably linked to an appropriate promoter, will modulate the level of transcription of an operably linked polynucleotide of interest. Biologically active fragments and variants of the enhancer domain may retain the biological activity of modulating (increase or decrease) the level of transcription when operably linked to an appropriate promoter.

The expression cassette may additionally contain 5′ leader sequences. Such leader sequences can act to enhance translation. Translation leaders are known in the art and include: picornavirus leaders, for example, EMCV leader (Encephalomyocarditis 5′ noncoding region) (Elroy-Stein et al. (1989) Proc. Natl. Acad. Sci. USA 86: 6126-6130); potyvirus leaders, for example, TEV leader (Tobacco Etch Virus) (Gallie et al. (1995) Gene 165(2): 233-238), MDMV leader (Maize Dwarf Mosaic Virus) (Virology 154: 9-20), and human immunoglobulin heavy-chain binding protein (BiP) (Macejak et al. (1991) Nature 353: 90-94); untranslated leader from the coat protein mRNA of alfalfa mosaic virus (AMV RNA 4) (Jobling et al. (1987) Nature 325: 622-625); tobacco mosaic virus leader (TMV) (Gallie et al. (1989) in Molecular Biology of RNA, ed. Cech (Liss, New York), pp. 237-256); and maize chlorotic mottle virus leader (MCMV) (Lommel et al. (1991) Virology 81: 382-385). See also, Della-Cioppa et al. (1987) Plant Physiol. 84: 965-968.

In preparing the expression cassette, the various polynucleotide fragments may be manipulated, so as to provide for sequences to be in the proper orientation and, as appropriate, in the proper reading frame. Toward this end, adapters or linkers may be employed to join the fragments or other manipulations may be involved to provide for convenient restriction sites, removal of superfluous material such as the removal of restriction sites, or the like. For this purpose, in vitro mutagenesis, primer repair, restriction, annealing, resubstitutions, e.g., transitions and transversions, may be involved. Standard recombinant DNA and molecular cloning techniques used herein are well known in the art and are described more fully, for example, in Sambrook et al. (1989) Molecular Cloning: A Laboratory Manual (Cold Spring Harbor Laboratory Press, Cold Spring Harbor) (also known as “Maniatis”).

In some embodiments, the polynucleotide of interest is targeted to the chloroplast for expression. In this manner, where the polynucleotide of interest is not directly inserted into the chloroplast, the expression cassette will additionally contain a nucleic acid encoding a transit peptide to direct the gene product of interest to the chloroplasts. Such transit peptides are known in the art. See, for example, Von Heijne et al. (1991) Plant Mol. Biol. Rep. 9: 104-126; Clark et al. (1989) J. Biol. Chem. 264: 17544-17550; Della-Cioppa et al. (1987) Plant Physiol. 84: 965-968; Romer et al. (1993) Biochem. Biophys. Res. Commun. 196: 1414-1421; and Shah et al. (1986) Science 233: 478-481.

Chloroplast targeting sequences are known in the art and include the chloroplast small subunit of ribulose-1,5-bisphosphate carboxylase (Rubisco) (de Castro Silva Filho et al. (1996) Plant Mol. Biol. 30: 769-780; Schnell et al. (1991) J. Biol. Chem. 266(5): 3335-3342); 5-(enolpyruvyl)shikimate-3-phosphate synthase (EPSPS) (Archer et al. (1990) J. Bioenerg. Biomemb. 22(6): 789-810); tryptophan synthase (Zhao et al. (1995) J. Biol. Chem. 270(11): 6081-6087); plastocyanin (Lawrence et al. (1997) J. Biol. Chem. 272(33): 20357-20363); chorismate synthase (Schmidt et al. (1993) J. Biol. Chem. 268(36): 27447-27457); and the light harvesting chlorophyll a/b binding protein (LHBP) (Lamppa et al. (1988) J. Biol. Chem. 263: 14996-14999). See also Von Heijne et al. (1991) Plant Mol. Biol. Rep. 9: 104-126; Clark et al. (1989) J. Biol. Chem. 264: 17544-17550; Della-Cioppa et al. (1987) Plant Physiol. 84: 965-968; Romer et al. (1993) Biochem. Biophys. Res. Commun. 196: 1414-1421; and Shah et al. (1986) Science 233: 478-481.

Methods for transformation of chloroplasts are known in the art. See, for example, Svab et al. (1990) Proc. Natl. Acad. Sci. USA 87: 8526-8530; Svab and Maliga (1993) Proc. Natl. Acad. Sci. USA 90: 913-917; Svab and Maliga (1993) EMBO J. 12: 601-606. The method relies on particle gun delivery of DNA containing a selectable marker and targeting of the DNA to the plastid genome through homologous recombination. Additionally, plastid transformation can be accomplished by transactivation of a silent plastid-borne transgene by tissue-preferred expression of a nuclear-encoded and plastid-directed RNA polymerase. Such a system has been reported in McBride et al. (1994) Proc. Natl. Acad. Sci. USA 91: 7301-7305.

The polynucleotides of interest to be targeted to the chloroplast may be optimized for expression in the chloroplast to account for differences in codon usage between the plant nucleus and this organelle. In this manner, the polynucleotide of interest may be synthesized using chloroplast-preferred codons. See, for example, U.S. Pat. No. 5,380,831, herein incorporated by reference.

“Gene” refers to a polynucleotide that expresses a specific protein, generally including regulatory sequences preceding (5′ non-coding sequences) and following (3′ non-coding sequences) the coding sequence (i.e., the portion of the sequence that encodes the specific protein). “Native gene” refers to a gene as found in nature, generally with its own regulatory sequences. A “transgene” is a gene that has been introduced into the genome by a transformation procedure. Accordingly, a “transgenic plant” is a plant that contains a transgene, whether the transgene was introduced into that particular plant by transformation or by breeding; thus, descendants of an originally-transformed plant are encompassed by the definition.

### III. Methods of Introducing

The plants of the invention are generated by introducing a polypeptide or polynucleotide into a plant. “Introducing” is intended to mean presenting to the plant the polynucleotide or polypeptide in such a manner that the sequence gains access to the interior of a cell of the plant. The methods of the invention do not depend on a particular method for introducing a sequence into a plant, only that the polynucleotide or polypeptides gains access to the interior of at least one cell of the plant. Methods for introducing polynucleotide or polypeptides into plants are known in the art including, but not limited to, stable transformation methods, transient transformation methods, virus-mediated methods, and breeding.

“Stable transformation” is intended to mean that the nucleotide construct introduced into a plant integrates into the genome of the plant and is capable of being inherited by the progeny thereof. “Transient transformation” is intended to mean that a polynucleotide is introduced into the plant and does not integrate into the genome of the plant or a polypeptide is introduced into a plant.

Transformation protocols as well as protocols for introducing polypeptides or polynucleotide sequences into plants may vary depending on the type of plant or plant cell (i.e., monocot or dicot) targeted for transformation. Suitable methods of introducing polypeptides and polynucleotides into plant cells include microinjection (Crossway et al. (1986) Biotechniques 4: 320-334), electroporation (Riggs et al. (1986) Proc. Natl. Acad. Sci. USA 83: 5602-5606, Agrobacterium-mediated transformation (U.S. Pat. No. 5,563,055 and U.S. Pat. No. 5,981,840), direct gene transfer (Paszkowski et al. (1984) EMBO J. 3: 2717-2722), and ballistic particle acceleration (see, for example, U.S. Pat. Nos. 4,945,050; U.S. Pat. No. 5,879,918; U.S. Pat. No. 5,886,244; and, 5,932,782; Tomes et al. (1995) in Plant Cell, Tissue, and Organ Culture: Fundamental Methods, ed. Gamborg and Phillips (Springer-Verlag, Berlin); McCabe et al. (1988) Biotechnology 6: 923-926); and Lec1 transformation (WO 00/28058). Also see Weissinger et al. (1988) Ann. Rev. Genet. 22: 421-477; Sanford et al. (1987) Particulate Science and Technology 5: 27-37 (onion); Christou et al. (1988) Plant Physiol. 87: 671-674 (soybean); McCabe et al. (1988) Bio/Technology 6: 923-926 (soybean); Finer and McMullen (1991) In Vitro Cell Dev. Biol. 27P: 175-182 (soybean); Singh et al. (1998) Theor. Appl. Genet. 96:319-324 (soybean); Datta et al. (1990) Biotechnology 8: 736-740 (rice); Klein et al. (1988) Proc. Natl. Acad. Sci. USA 85:4305-4309 (maize); Klein et al. (1988) Biotechnology 6:559-563 (maize); U.S. Pat. Nos. 5,240,855; 5,322,783; and, 5,324,646; Klein et al. (1988) Plant Physiol. 91: 440-444 (maize); Fromm et al. (1990) Biotechnology 8: 833-839 (maize); protocols published electronically by “IP.com” under the permanent publication identifiers IPCOM000033402D, IPCOM000033402D, and IPCOM000033402D and available at the “IP.com” website (cotton); Hooykaas-Van Slogteren et al. (1984) Nature (London) 311: 763-764; U.S. Pat. No. 5,736,369 (cereals); Bytebier et al. (1987) Proc. Natl. Acad. Sci. USA 84: 5345-5349 (Liliaceae); De Wet et al. (1985) in The Experimental Manipulation of Ovule Tissues, ed. Chapman et al. (Longman, N.Y.), pp. 197-209 (pollen); Kaeppler et al. (1990) Plant Cell Reports 9: 415-418 and Kaeppler et al. (1992) Theor. Appl. Genet. 84: 560-566 (whisker-mediated transformation); D'Halluin et al. (1992) Plant Cell 4: 1495-1505 (electroporation); Li et al. (1993) Plant Cell Reports 12: 250-255 and Christou and Ford (1995) Annals of Botany 75: 407-413 (rice); Osjoda et al. (1996) Nature Biotechnology 14: 745-750 (maize via Agrobacterium tumefaciens); all of which are herein incorporated by reference.

In specific embodiments, herbicide-tolerance or other desirable sequences can be provided to a plant using a variety of transient transformation methods. Such transient transformation methods include, but are not limited to, the introduction of the polypeptide or variants and fragments thereof directly into the plant or the introduction of a transcript into the plant. Such methods include, for example, microinjection or particle bombardment. See, for example, Crossway et al. (1986) Mol. Gen. Genet. 202: 179-185; Nomura et al. (1986) Plant Sci. 44: 53-58; Hepler et al. (1994) Proc. Natl. Acad. Sci. 91: 2176-2180 and Hush et al. (1994) The Journal of Cell Science 107: 775-784, all of which are herein incorporated by reference. Alternatively, a herbicide-tolerance polynucleotide can be transiently transformed into the plant using techniques known in the art. Such techniques include viral vector system and the precipitation of the polynucleotide in a manner that precludes subsequent release of the DNA. Thus, the transcription from the particle-bound DNA can occur, but the frequency with which it is released to become integrated into the genome is greatly reduced. Such methods include the use particles coated with polyethylimine (PEI; Sigma #P3143).

In other embodiments, polynucleotides may be introduced into plants by contacting plants with a virus or viral nucleic acids. Generally, such methods involve incorporating a nucleotide construct within a viral DNA or RNA molecule. It is recognized that a polypeptide of interest may be initially synthesized as part of a viral polyprotein, which later may be processed by proteolysis in vivo or in vitro to produce the desired recombinant protein. Further, it is recognized that useful promoters may include promoters utilized for transcription by viral RNA polymerases. Methods for introducing polynucleotides into plants and expressing a polypeptide encoded thereby, involving viral DNA or RNA molecules, are known in the art. See, for example, U.S. Pat. Nos. 5,889,191, 5,889,190, 5,866,785, 5,589,367, 5,316,931, and Porta et al. (1996) Molecular Biotechnology 5: 209-221; herein incorporated by reference.

Methods are known in the art for the targeted insertion of a polynucleotide at a specific location in the plant genome. In one embodiment, the insertion of the polynucleotide at a desired genomic location is achieved using a site-specific recombination system. See, for example, WO99/25821, WO99/25854, WO99/25840, WO99/25855, and WO99/25853, all of which are herein incorporated by reference. Briefly, a polynucleotide can be contained in transfer cassette flanked by two non-recombinogenic recombination sites. The transfer cassette is introduced into a plant having stably incorporated into its genome a target site which is flanked by two non-recombinogenic recombination sites that correspond to the sites of the transfer cassette. An appropriate recombinase is provided and the transfer cassette is integrated at the target site. The polynucleotide of interest is thereby integrated at a specific chromosomal position in the plant genome.

The cells that have been transformed may be grown into plants in accordance with conventional ways. See, for example, McCormick et al. (1986) Plant Cell Reports 5: 81-84. These plants may then be grown, and either pollinated with the same transformed strain or different strains, and the resulting progeny having constitutive expression of the desired phenotypic characteristic identified. Two or more generations may be grown to ensure that expression of the desired phenotypic characteristic is stably maintained and inherited and then seeds harvested to ensure expression of the desired phenotypic characteristic has been achieved. In this manner, the present invention provides transformed seed (also referred to as “transgenic seed”) having a polynucleotide of the invention, for example, an expression cassette of the invention, stably incorporated into their genome.

In specific embodiments, a polypeptide or the polynucleotide of interest is introduced into the plant cell. Subsequently, a plant cell having the introduced sequence is selected using methods known to those of skill in the art such as, but not limited to, Southern blot analysis, DNA sequencing, PCR analysis, or phenotypic analysis. A plant or plant part altered or modified by the foregoing embodiments is grown under plant forming conditions for a time sufficient to modulate the concentration and/or activity of polypeptides in the plant. Plant forming conditions are well known in the art and discussed briefly elsewhere herein.

It is recognized that methods of the present invention do not depend on the incorporation of the entire polynucleotide into the genome, only that the plant or cell thereof is altered as a result of the introduction of the polynucleotide into a cell. In one embodiment of the invention, the genome may be altered following the introduction of the polynucleotide into a cell. For example, the polynucleotide, or any part thereof, may incorporate into the genome of the plant. Alterations to the genome of the present invention include, but are not limited to, additions, deletions, and substitutions of nucleotides into the genome. While the methods of the present invention do not depend on additions, deletions, and substitutions of any particular number of nucleotides, it is recognized that such additions, deletions, or substitutions comprises at least one nucleotide.

Plants of the invention may be produced by any suitable method, including breeding. Plant breeding can be used to introduce desired characteristics (e.g., a stably incorporated transgene or a genetic variant or genetic alteration of interest) into a particular plant line of interest, and can be performed in any of several different ways. Pedigree breeding starts with the crossing of two genotypes, such as an elite line of interest and one other elite inbred line having one or more desirable characteristics (i.e., having stably incorporated a polynucleotide of interest, having a modulated activity and/or level of the polypeptide of interest, etc.) which complements the elite plant line of interest. If the two original parents do not provide all the desired characteristics, other sources can be included in the breeding population. In the pedigree method, superior plants are selfed and selected in successive filial generations. In the succeeding filial generations the heterozygous condition gives way to homogeneous lines as a result of self-pollination and selection. Typically in the pedigree method of breeding, five or more successive filial generations of selfing and selection is practiced: F1→F2; F2→F3; F3→F4; F4→F5, etc. After a sufficient amount of inbreeding, successive filial generations will serve to increase seed of the developed inbred. In specific embodiments, the inbred line comprises homozygous alleles at about 95% or more of its loci. Various techniques known in the art can be used to facilitate and accelerate the breeding (e.g., backcrossing) process, including, for example, the use of a greenhouse or growth chamber with accelerated day/night cycles, the analysis of molecular markers to identify desirable progeny, and the like.

In addition to being used to create a backcross conversion, backcrossing can also be used in combination with pedigree breeding to modify an elite line of interest and a hybrid or variety that is made using the modified elite line. As discussed previously, backcrossing can be used to transfer one or more specifically desirable traits from one line, the donor parent, to an inbred called the recurrent parent, which has overall good agronomic characteristics yet lacks that desirable trait or traits. However, the same procedure can be used to move the progeny toward the genotype of the recurrent parent but at the same time retain many components of the non-recurrent parent by stopping the backcrossing at an early stage and proceeding with selfing and selection. For example, an F1, such as a commercial hybrid, or an elite variety is created. This commercial hybrid or variety may be backcrossed to one of its parent lines to create a BC1 or BC2. Progeny are selfed and selected so that the newly developed inbred or line has many of the attributes of the recurrent parent and yet several of the desired attributes of the non-recurrent parent. This approach leverages the value and strengths of the recurrent parent for use in new hybrids or varieties and additional breeding.

Therefore, an embodiment of this invention is a method of making a backcross conversion of an inbred line or variety of interest comprising the steps of crossing a plant from the inbred line or variety of interest with a donor plant comprising at least one mutant gene or transgene conferring a desired trait (e.g., herbicide tolerance), selecting an F1 progeny plant comprising the mutant gene or transgene conferring the desired trait, and backcrossing the selected F1 progeny plant to a plant of the inbred line or variety of interest. This method may further comprise the step of obtaining a molecular marker profile of the inbred line or variety of interest and using the molecular marker profile to select for a progeny plant with the desired trait and the molecular marker profile of the inbred line or variety of interest. In the same manner, this method may be used to produce F1 hybrid seed by adding a final step of crossing the desired trait conversion of the inbred line of interest with a different plant to make F1 hybrid seed comprising a mutant gene or transgene conferring the desired trait.

Recurrent selection is a method used in a plant breeding program to improve a population of plants. The method entails individual plants cross pollinating with each other to form progeny. The progeny are grown and the superior progeny selected by any number of selection methods, which include individual plant, half-sib progeny, full-sib progeny, selfed progeny and topcrossing. The selected progeny are cross-pollinated with each other to form progeny for another segregating population. This population is planted and again superior plants are selected to cross pollinate with each other. Recurrent selection is a cyclical process and therefore can be repeated as many times as desired. The objective of recurrent selection is to improve the traits of a population. The improved population can then be used as a source of breeding material to obtain inbred lines to be used in hybrids or variety development, or used as parents for a synthetic cultivar. A synthetic cultivar is the resultant progeny formed by the intercrossing of several selected inbreeds.

Mass selection is a useful technique when used in conjunction with molecular marker enhanced selection. In mass selection seeds from individuals are selected based on phenotype and/or genotype. These selected seeds are then bulked and used to grow the next generation. Bulk selection requires growing a population of plants in a bulk plot, allowing the plants to self-pollinate, harvesting the seed in bulk and then using a sample of the seed harvested in bulk to plant the next generation. Instead of self pollination, directed pollination could be used as part of the breeding program.

Mutation breeding is one of many methods that could be used to introduce new traits into an elite line. Mutations that occur spontaneously or are artificially induced can be useful sources of variability for a plant breeder. The goal of artificial mutagenesis is to increase the rate of mutation for a desired characteristic. Mutation rates can be increased by many different means including temperature, long-term seed storage, tissue culture conditions, radiation such as X-rays, Gamma rays (e.g., cobalt 60 or cesium 137), neutrons, (product of nuclear fission of uranium 235 in an atomic reactor), Beta radiation (emitted from radioisotopes such as phosphorus 32 or carbon 14), or ultraviolet radiation (preferably from 2500 to 2900 nm), or chemical mutagens (such as base analogues (5-bromo-uracil), related compounds (8-ethoxy caffeine), antibiotics (streptonigrin), alkylating agents (sulfur mustards, nitrogen mustards, epoxides, ethylenamines, sulfates, sulfonates, sulfones, lactones), azide, hydroxylamine, nitrous acid, or acridines. Once a desired trait is observed through mutagenesis the trait may then be incorporated into existing germplasm by traditional breeding techniques, such as backcrossing. Details of mutation breeding can be found in “Principals of Cultivar Development” (Fehr, 1993 Macmillan Publishing Company) the disclosure of which is incorporated herein by reference. In addition, mutations created in other lines may be used to produce a backcross conversion of elite lines that comprises such mutations.

### IV. Methods of Improving Yield

The multi-mode of action glyphosate-tolerant plants comprising sequences encoding at least two polypeptides, wherein each of the polypeptides imparts tolerance to glyphosate via a distinct mode of action can be employed in various methods to increase yield of the plant in the presence of glyphosate when compared to an appropriate control plant.

As used herein, an “area of cultivation” comprises any region in which one desires to grow a plant. Such areas of cultivations include, but are not limited to, a field in which a plant is cultivated (such as a crop field, a sod field, a tree field, a managed forest, a field for culturing fruits and vegetables, etc), a greenhouse, a growth chamber, etc.

The methods of the invention comprise planting the area of cultivation with the multi-mode of action glyphosate-tolerant crop seeds or plants of the invention, and applying to any crop, crop part, weed or area of cultivation thereof an effective amount of glyphosate. It is recognized that the herbicide can be applied before or after the crop is planted in the area of cultivation. A “control” or “control plant” or “control plant cell” provides a reference point for measuring changes in phenotype (i.e., improved yield) of the subject plant or plant cell, and may be any suitable plant or plant cell.

An improved yield can be can be evaluated by statistical analysis of suitable parameters. The plant being evaluated is referred to as the “test plant.” Typically, an appropriate control plant is one that expresses one of the glyphosate-tolerance sequences that is present in the test plant but lacks or does not express additional (second, third, etc.) glyphosate-tolerance sequences in the test plant. For example, in evaluating multi-mode of action glyphosate-tolerant plants of the invention, an appropriate control plant would be a plant that expresses GLYAT and not EPSPS or one that expresses EPSPS and not GLYAT, or one that expresses GLYAT and not glyphosate oxido-reductase or one that expresses glyphosate oxido-reductase and not GLYAT. One skilled in the art will be able to design, perform, and evaluate a suitable controlled experiment to assess the glyphosate tolerance of a plant of interest and the improved yield, including the selection of appropriate test plants, control plants, and treatments.

The improved yield of the multi-mode of action glyphosate-tolerant plant can be assessed at various times after a plant has been treated with the glyphosate. Improved yield is ultimately determined as productivity relative for the product (fresh cut weight, silage yield, mature grain harvest). Improved yield determination can occur at any stage of maturity of the test plant by assessing yield component measures. Any time of assessment is suitable as long as it permits detection of an improved yield of test plants as compared to the control plants. Flower number could be measured at R2. Plant biomass could be measured at anytime during the growing season but measurements would be applicable to only that exact point in crop stage. Seed yield, seed size, and seed number is reliably measured at crop growth stage R7 or R8. In the case of crops such as vegetables, plant fresh weight is determined at or before peak produce harvest.

As used herein, an “effective amount of glyphosate” is one that is sufficient to improve the yield in the plants having the glyphosate-tolerant sequences which act via two distinct modes of action and further comprises an amount that is tolerated by the plant, and in specific embodiments, the effective amount is further capable of controlling weeds in the area of cultivation. It is further recognized that when the multi-mode of action glyphosate tolerant plants further comprises additional traits that impart tolerance to other herbicides, the methods of the invention can comprise applying to such plants glyphosate plus an additional appropriate herbicide. In such cases, an “effective amount of a herbicide” is one that is tolerated by the plant and controls weeds in the area of cultivation.

“Herbicide-tolerant” or “tolerant” or “crop tolerance” in the context of herbicide or other chemical treatment as used herein means that a plant or other organism treated with a particular herbicide or class or subclass of herbicide or other chemical or class or subclass of other chemical will show no significant damage or less damage following that treatment in comparison to an appropriate control plant. The term “controlling,” and derivations thereof, for example, as in “controlling weeds” refers to one or more of inhibiting the growth, germination, reproduction, and/or proliferation of; and/or killing, removing, destroying, or otherwise diminishing the occurrence and/or activity of a weed.

Thus, a plant is tolerant to a herbicide if it shows damage in comparison to an appropriate control plant that is less than the damage exhibited by the control plant by at least 5%, 10%, 15%, 20%, 25%, 30%, 35%, 40%, 45%, 50%, 55%, 60%, 65%, 70%, 75%, 80%, 90%, 100%, 150%, 200%, 250%, 300%, 400%, 500%, 600%, 700%, 800%, 900%, or 1000% or more. In this manner, a plant that is tolerant to a herbicide or other chemical shows “improved tolerance” in comparison to an appropriate control plant. Damage resulting from herbicide or other chemical treatment is assessed by evaluating any parameter of plant growth or well-being deemed suitable by one of skill in the art. Damage can be assessed by visual inspection and/or by statistical analysis of suitable parameters of individual plants or of a group of plants. Thus, damage may be assessed by evaluating, for example, parameters such as plant height, plant weight, leaf color, leaf length, flowering, fertility, silking, yield, seed production, and the like. Damage may also be assessed by evaluating the time elapsed to a particular stage of development (e.g., silking, flowering, or pollen shed) or the time elapsed until a plant has recovered from treatment with a particular chemical and/or herbicide.

In making such assessments, particular values may be assigned to particular degrees of damage so that statistical analysis or quantitative comparisons may be made. The use of ranges of values to describe particular degrees of damage is known in the art, and any suitable range or scale may be used. For example, herbicide injury scores (also called tolerance scores) can be assigned using the scale set forth are known in the art.

By “no significant damage” is intended that the concentration of herbicide either has no effect on the plant or when it has some effect on a plant from which the plant later recovers, or when it has an effect which is detrimental but which is offset, for example, by the impact of the particular herbicide on weeds. Thus, for example, a crop plant is not “significantly damaged by” a herbicide or other treatment if it exhibits less than 50%, 40%,35%,30%,25%,20%, 15%, 10%,9%,8%,7%,6%,5%,4%,3%,2%, or 1% decrease in at least one suitable parameter that is indicative of plant health and/or productivity in comparison to an appropriate control plant (e.g., an untreated crop plant). Suitable parameters that are indicative of plant health and/or productivity include, for example, plant height, plant weight, leaf length, time elapsed to a particular stage of development, flowering, yield, seed production, and the like. The evaluation of a parameter can be by visual inspection and/or by statistical analysis of any suitable parameter. Comparison may be made by visual inspection and/or by statistical analysis. Accordingly, a crop plant is not “significantly damaged by” a herbicide or other treatment if it exhibits a decrease in at least one parameter but that decrease is temporary in nature and the plant recovers fully within 1 week, 2 weeks, 3 weeks, 4 weeks, 5 weeks, or 6 weeks.

Conversely, a plant is significantly damaged by a herbicide or other treatment if it exhibits more than a 50%, 55%, 60%, 65%, 70%, 75%, 80%, 85%, 90%, 95%, 100%, 105%, 110%, 115%, 120%, 125%, 130%, 135%, 140%, 145%, 150%, or higher decrease in at least one suitable parameter that is indicative of plant health and/or productivity in comparison to an appropriate control plant (e.g., an untreated weed of the same species). Thus, a plant is significantly damaged if it exhibits a decrease in at least one parameter and the plant does not recover fully within 1 week, 2 weeks, 3 weeks, 4 weeks, 5 weeks, or 6 weeks.

Glyphosate can be applied to the multi-mode of action glyphosate-tolerant plants or their area of cultivation. Non-limiting examples of glyphosate formations are set forth in Table 1. In specific embodiments, the glyphosate is in the form of a salt, such as, ammonium, isopropylammonium, potassium, sodium (including sesquisodium) or trimesium (alternatively named sulfosate).

TABLE 1
Glyphosate formulations comparisons.

| | | Active | Acid |
|---|---|---|---|
| Glyphosate | | ingredient | equivelent |
| Formulation | Salt | per gallon | per gallon |
| Roundup | Potassium | 5.5 | 4.5 |
| Original MAX ™ | | | |
| Roundup | Isopropylamine | 5 | 3.68 |
| UltraMax ™ | | | |
| Roundup | Potassium | 5.5 | 4.5 |
| PowerMax ™ | | | |
| Roundup | Potassium | 5.5 | 4.5 |
| Weathermax ™ | | | |
| Touchdown | Potassium | 6.16 | 5 |
| HiTech ™ | | | |
| Touchdown | Potassium | 5.14 | 4.17 |
| Total ™ | | | |
| Durango ™ | Isopropylamine | 5.4 | 4 |
| Glyphomax ™ | Isopropylamine | 4 | 3 |
| Glyphomax | Isopropylamine | 4 | 3 |
| Plus ™ | | | |
| Gly Star Plus ™ | Isopropylamine | 4 | 3 |
| Gly Star 5 ™ | Isopropylamine | 5.4 | 4 |
| Gly Star | Isopropylamine | 4 | 3 |
| Original ™ | | | |
| Cornerstone ™ | Isopropylamine | 4 | 3 |
| Cornerstone | Isopropylamine | 4 | 3 |
| Plus ™ | | | |
| Rascal ™ | Isopropylamine | 4 | 3 |
| Rascal Plus ™ | Isopropylamine | 4 | 3 |
| Rattler ™ | Isopropylamine | 4 | 3 |
| Rattler Plus ™ | Isopropylamine | 4 | 3 |
| Mirage Plus ™ | Isopropylamine | 4 | 3 |
| Buccaneer ™ | Isopropylamine | 4 | 3 |
| Buccaneer | Isopropylamine | 4 | 3 |
| Plus ™ | | | |
| Honcho ™ | Isopropylamine | 4 | 3 |
| Honcho Plus ™ | Isopropylamine | 4 | 3 |
| Gly-4 ™ | Isopropylamine | 4 | 3 |
| Gly-4 Plus ™ | Isopropylamine | 4 | 3 |
| ClearOut 41 | Isopropylamine | 4 | 3 |
| Plus ™ | | | |

In other embodiments, glyphosate is a glyphosate derivative comprising a salt or a mixture of glyphosate salts selected from the group consisting of: mono-isopropylammonium glyphosate, ammonium glyphosate, and sodium glyphosate. In further embodiments, glyphosate is used in a formulation comprising: an adjuvant selected from the group consisting of: amines, ethoxylated alkyl amines, tallow amines, cocoamines, amine oxides, quaternary ammonium salts, ethoxylated quaternary ammonium salts, propoxylated quaternary ammonium salts, alkylpolyglycoside, alkylglycoside, glucose-esters, sucrose-esters, and ethoxylated polypropoxylated quaternary ammonium surfactants.

In some embodiments, a method of improving yield in a multi-mode of action glyphosate-tolerant plant comprises a treatment with the glyphosate applied to that plant at a dose equivalent to a rate of at least 210, 420, 840, 1260, 1680, 2100, 2520, 2940, 3360, 3780, 4200, 4620, 5040, 5460, 5880, 6300, 6720, or more grams of acid equivalent of glyphosate in a commercial herbicide formulation herbicide per hectare.

In other embodiments, glyphosate is applied to an area of cultivation and/or to at least one multi-mode of action glyphosate tolerant plant in an area of cultivation at rates between 210 and 3360 grams acid equivalent per hectare at the lower end of the range of application and between 3780 and 6720 grams of acid equivalent per hectare at the higher end of the range of application. The preferred range of glyphosate application for soybean is a single dose of up to 1680 grams acid equivalent per hectare, and a full in-crop season dose up to 2520 grams acid equivalent per hectare. Other crops will have different preferred ranges of glyphosate application.

As is known in the art, glyphosate herbicides as a class contain the same active ingredient, but the active ingredient is present as one of a number of different salts and/or formulations. One of skill in the art is familiar with the determination of the amount of active ingredient and/or acid equivalent present in a particular volume and/or weight of herbicide preparation.

a. Timing of Herbicide Application

Methods to improve yield allow for the application of glyphosate any time after glyphosate tolerant seeds are planted in an area of cultivation. “Preemergent” refers to a herbicide which is applied to an area of interest (e.g., a field or area of cultivation) before a plant emerges visibly from the soil. “Postemergent” refers to a herbicide which is applied to an area after a plant emerges visibly from the soil. In some instances, the terms “preemergent” and “postemergent” are used with reference to a weed in an area of interest, and in some instances these terms are used with reference to a crop plant in an area of interest. When used with reference to a weed, these terms may apply to only a particular type of weed or species of weed that is present or believed to be present in the area of interest. “Preplant incorporation” involves the incorporation of compounds into the soil prior to planting.

The time at which glyphosate is applied may be determined with reference to the size of plants and/or the stage of growth and/or development of plants in the area of interest, e.g., crop plants or weeds growing in the area. The stages of growth and/or development of plants are known in the art. For example, soybean plants normally progress through vegetative growth stages known as V_{E} (emergence), V_{C} (cotyledon), V₁ (unifoliate), and V₂ to V_{N}. Soybeans then switch to the reproductive growth phase in response to photoperiod cues; reproductive stages include R₁ (beginning bloom), R₂ (full bloom), R₃ (beginning pod), R₄ (full pod), R₅ (beginning seed), R₆ (full seed), R₇ (beginning maturity), and R₉ (full maturity). Corn plants normally progress through the following vegetative stages VE (emergence); V1 (first leaf); V2 (second leaf); V3 (third leaf); V(n) (Nth/leaf); and VT (tasseling). Progression of maize through the reproductive phase is as follows: R1 (silking); R2 (blistering); R3 (milk); R4 (dough); R5 (dent); and R6 (physiological maturity). Cotton plants normally progress through V_{E} (emergence), V_{C} (cotyledon), V₁ (first true leaf), and V₂ to V_{N}. Then, reproductive stages beginning around V₁₄ include R₁ (beginning bloom), R₂ (full bloom), R₃ (beginning boll), R₄ (cutout, boll development), R₅ (beginning maturity, first opened boll), R₆ (maturity, 50% opened boll), and R₇ (full maturity, 80-90% open bolls). Thus, for example, the time at which glyphosate is applied to an area of interest in which plants are growing may be the time at which some or all of the plants in a particular area have reached at least a particular size and/or stage of growth and/or development, or the time at which some or all of the plants in a particular area have not yet reached a particular size and/or stage of growth and/or development.

a. Additional Types of Herbicides

As discussed above, the multi-mode of action glyphosate-tolerant plant can further comprise sequences that impart tolerance to additional herbicides. Thus, depending on the additional sequences present in the plant, the methods of the invention can further comprise applying additional herbicides of interest to the plant and thereby improve yield and control weeds in an area of cultivation. Thus, the methods of the invention encompass the use of simultaneous and/or sequential applications of multiple classes of herbicides. When glyphosate is used with additional herbicides of interest, the application of the herbicide combination need not occur at the same time. So long as the field in which the crop is planted contains detectable amounts of the first herbicide and the second herbicide is applied at some time during the period in which the crop is in the area of cultivation, the crop is considered to have been treated with a mixture of herbicides according to the invention. Thus, methods encompass applications of herbicide combinations which are “preemergent,” “postemergent,” “preplant incorporated” and/or which involve seed treatment prior to planting.

The classifications of herbicides (i.e., the grouping of herbicides into classes and subclasses) is well-known in the art and includes classifications by HRAC (Herbicide Resistance Action Committee) and WSSA (the Weed Science Society of America) (see also, Retzinger and Mallory-Smith (1997) Weed Technology 11: 384-393). An abbreviated version of the HRAC classification (with notes regarding the corresponding WSSA group) is set forth below in Table 2. A more comprehensive list of specific herbicides can be found for example, in U.S. Application Publication 2007/0130641, herein incorporated by reference.

Herbicides can be classified by their mode of action and/or site of action and can also be classified by the time at which they are applied (e.g., preemergent or postemergent), by the method of application (e.g., foliar application or soil application), or by how they are taken up by or affect the plant. For example, thifensulfuron-methyl and tribenuron-methyl are applied to the foliage of a crop (e.g., maize) and are generally metabolized there, while rimsulfuron and chlorimuron-ethyl are generally taken up through both the roots and foliage of a plant. Herbicides can be classified in various ways, including by mode of action and/or site of action (see, e.g., Table 2).

TABLE 2
Abbreviated version of HRAC Herbicide Classification

| I. | ALS Inhibitors (WSSA Group 2) | | | |
|---|---|---|---|---|
| | A. | Sulfonylureas | | |
| | | 1. | Azimsulfuron | |
| | | 2. | Chlorimuron-ethyl | |
| | | 3. | Metsulfuron-methyl | |
| | | 4. | Nicosulfuron | |
| | | 5. | Rimsulfuron | |
| | | 6. | Sulfometuron-methyl | |
| | | 7. | Thifensulfuron-methyl | |
| | | 8. | Tribenuron-methyl | |
| | | 9. | Amidosulfuron | |
| | | 10. | Bensulfuron-methyl | |
| | | 11. | Chlorsulfuron | |
| | | 12. | Cinosulfuron | |
| | | 13. | Cyclosulfamuron | |
| | | 14. | Ethametsulfuron-methyl | |
| | | 15. | Ethoxysulfuron | |
| | | 16. | Flazasulfuron | |
| | | 17. | Flupyrsulfuron-methyl | |
| | | 18. | Foramsulfuron | |
| | | 19. | Imazosulfuron | |
| | | 20. | Iodosulfuron-methyl | |
| | | 21. | Mesosulfuron-methyl | |
| | | 22. | Oxasulfuron | |
| | | 23. | Primisulfuron-methyl | |
| | | 24. | Prosulfuron | |
| | | 25. | Pyrazosulfuron-ethyl | |
| | | 26. | Sulfosulfuron | |
| | | 27. | Triasulfuron | |
| | | 28. | Trifloxysulfuron | |
| | | 29. | Triflusulfuron-methyl | |
| | | 30. | Tritosulfuron | |
| | | 31. | Halosulfuron-methyl | |
| | | 32. | Flucetosulfuron | |
| | B. | Sulfonylaminocarbonyltriazolinones | | |
| | | 1. | Flucarbazone | |
| | | 2. | Procarbazone | |
| | C. | Triazolopyrimidines | | |
| | | 1. | Cloransulam-methyl | |
| | | 2. | Flumetsulam | |
| | | 3. | Diclosulam | |
| | | 4. | Florasulam | |
| | | 5. | Metosulam | |
| | | 6. | Penoxsulam | |
| | | 7. | Pyroxsulam | |
| | D. | Pyrimidinyloxy(thio)benzoates | | |
| | | 1. | Bispyribac | |
| | | 2. | Pyriftalid | |
| | | 3. | Pyribenzoxim | |
| | | 4. | Pyrithiobac | |
| | | 5. | Pyriminobac-methyl | |
| | E. | Imidazolinones | | |
| | | 1. | Imazapyr | |
| | | 2. | Imazethapyr | |
| | | 3. | Imazaquin | |
| | | 4. | Imazapic | |
| | | 5. | Imazamethabenz-methyl | |
| | | 6. | Imazamox | |
| II. | Other Herbicides--Active Ingredients/ | | | |
| | Additional Modes of Action | | | |
| | A. | Inhibitors of Acetyl CoA carboxylase | | |
| | | (ACCase) (WSSA Group 1) | | |
| | | 1. | Aryloxyphenoxypropionates (‘FOPs’) | |
| | | | a. | Quizalofop-P-ethyl |
| | | | b. | Diclofop-methyl |
| | | | c. | Clodinafop-propargyl |
| | | | d. | Fenoxaprop-P-ethyl |
| | | | e. | Fluazifop-P-butyl |
| | | | f. | Propaquizafop |
| | | | g. | Haloxyfop-P-methyl |
| | | | h. | Cyhalofop-butyl |
| | | | i. | Quizalofop-P-ethyl |
| | | 2. | Cyclohexanediones (‘DIMs’) | |
| | | | a. | Alloxydim |
| | | | b. | Butroxydim |
| | | | c. | Clethodim |
| | | | d. | Cycloxydim |
| | | | e. | Sethoxydim |
| | | | f. | Tepraloxydim |
| | | | g. | Tralkoxydim |
| | B. | Inhibitors of Photosystem II-HRAC | | |
| | | Group C1/WSSA Group 5 | | |
| | | 1. | Triazines | |
| | | | a. | Ametryne |
| | | | b. | Atrazine |
| | | | c. | Cyanazine |
| | | | d. | Desmetryne |
| | | | e. | Dimethametryne |
| | | | f. | Prometon |
| | | | g. | Prometryne |
| | | | h. | Propazine |
| | | | i. | Simazine |
| | | | j. | Simetryne |
| | | | k. | Terbumeton |
| | | | l. | Terbuthylazine |
| | | | m. | Terbutryne |
| | | | n. | Trietazine |
| | | 2. | Triazinones | |
| | | | a. | Hexazinone |
| | | | b. | Metribuzin |
| | | | c. | Metamitron |
| | | 3. | Triazolinone | |
| | | | a. | Amicarbazone |
| | | 4. | Uracils | |
| | | | a. | Bromacil |
| | | | b. | Lenacil |
| | | | c. | Terbacil |
| | | 5. | Pyridazinones | |
| | | | a. | Pyrazon |
| | | 6. | Phenyl carbamates | |
| | | | a. | Desmedipham |
| | | | b. | Phenmedipham |
| | C. | Inhibitors of Photosystem II-HRAC | | |
| | | Group C2/WSSA Group 7 | | |
| | | 1. | Ureas | |
| | | | a. | Fluometuron |
| | | | b. | Linuron |
| | | | c. | Chlorobromuron |
| | | | d. | Chlorotoluron |
| | | | e. | Chloroxuron |
| | | | f. | Dimefuron |
| | | | g. | Diuron |
| | | | h. | Ethidimuron |
| | | | i. | Fenuron |
| | | | j. | Isoproturon |
| | | | k. | Isouron |
| | | | l. | Methabenzthiazuron |
| | | | m. | Metobromuron |
| | | | n. | Metoxuron |
| | | | o. | Monolinuron |
| | | | p. | Neburon |
| | | | q. | Siduron |
| | | | r. | Tebuthiuron |
| | | 2. | Amides | |
| | | | a. | Propanil |
| | | | b. | Pentanochlor |
| | D. | Inhibitors of Photosystem II-HRAC | | |
| | | Group C3/WSSA Group 6 | | |
| | | 1. | Nitriles | |
| | | | a. | Bromofenoxim |
| | | | b. | Bromoxynil |
| | | | c. | Ioxynil |
| | | 2. | Benzothiadiazinone (Bentazon) | |
| | | | a. | Bentazon |
| | | 3. | Phenylpyridazines | |
| | | | a. | Pyridate |
| | | | b. | Pyridafol |
| | E. | Photosystem-I-electron diversion | | |
| | | (Bipyridyliums) (WSSA Group 22) | | |
| | | 1. | Diquat | |
| | | 2. | Paraquat | |
| | F. | Inhibitors of PPO (protoporphyrinogen | | |
| | | oxidase) (WSSA Group 14) | | |
| | | 1. | Diphenylethers | |
| | | | a. | Acifluorfen-Na |
| | | | b. | Bifenox |
| | | | c. | Chlomethoxyfen |
| | | | d. | Fluoroglycofen-ethyl |
| | | | e. | Fomesafen |
| | | | f. | Halosafen |
| | | | g. | Lactofen |
| | | | h. | Oxyfluorfen |
| | | 2. | Phenylpyrazoles | |
| | | | a. | Fluazolate |
| | | | b. | Pyraflufen-ethyl |
| | | 3. | N-phenylphthalimides | |
| | | | a. | Cinidon-ethyl |
| | | | b. | Flumioxazin |
| | | | c. | Flumiclorac-pentyl |
| | | 4. | Thiadiazoles | |
| | | | a. | Fluthiacet-methyl |
| | | | b. | Thidiazimin |
| | | 5. | Oxadiazoles | |
| | | | a. | Oxadiazon |
| | | | b. | Oxadiargyl |
| | | 6. | Triazolinones | |
| | | | a. | Carfentrazone-ethyl |
| | | | b. | Sulfentrazone |
| | | 7. | Oxazolidinediones | |
| | | | a. | Pentoxazone |
| | | 8. | Pyrimidindiones | |
| | | | a. | Benzfendizone |
| | | | b. | Butafenicil |
| | | 9. | Others | |
| | | | a. | Pyrazogyl |
| | | | b. | Profluazol |
| | G. | Bleaching: Inhibition of carotenoid | | |
| | | biosynthesis at the phytoene desaturase step | | |
| | | (PDS) (WSSA Group 12) | | |
| | | 1. | Pyridazinones | |
| | | | a. | Norflurazon |
| | | 2. | Pyridinecarboxamides | |
| | | | a. | Diflufenican |
| | | | b. | Picolinafen |
| | | 3. | Others | |
| | | | a. | Beflubutamid |
| | | | b. | Fluridone |
| | | | c. | Flurochloridone |
| | | | d. | Flurtamone |
| | H. | Bleaching: Inhibition of 4- | | |
| | | hydroxyphenyl-pyruvate-dioxygenase (4-HPPD) | | |
| | | (WSSA Group 28) | | |
| | | 1. | Triketones | |
| | | | a. | Mesotrione |
| | | | b. | Sulcotrione |
| | | 2. | Isoxazoles | |
| | | | a. | Isoxachlortole |
| | | | b. | Isoxaflutole |
| | | 3. | Pyrazoles | |
| | | | a. | Benzofenap |
| | | | b. | Pyrazoxyfen |
| | | | c. | Pyrazolynate |
| | | 4. | Others | |
| | | | a. | Benzobicyclon |
| | I. | Bleaching: Inhibition of carotenoid | | |
| | | biosynthesis (unknown target) (WSSA Group 11 | | |
| | | and 13) | | |
| | | 1. | Triazoles (WSSA Group 11) | |
| | | | a. | Amitrole |
| | | 2. | Isoxazolidinones (WSSA Group 13) | |
| | | | a. | Clomazone |
| | | 3. | Ureas | |
| | | | a. | Fluometuron |
| | | 3. | Diphenylether | |
| | | | a. | Aclonifen |
| | J. | Inhibition of EPSP Synthase | | |
| | | 1. | Glycines (WSSA Group 9) | |
| | | | a. | Glyphosate |
| | | | b. | Sulfosate |
| | K. | Inhibition of glutamine synthetase | | |
| | | 1. | Phosphinic Acids | |
| | | | a. | Glufosinate-ammonium |
| | | | b. | Bialaphos |
| | L. | Inhibition of DHP (dihydropteroate) | | |
| | | synthase (WSSA Group 18) | | |
| | | 1 | Carbamates | |
| | | | a. | Asulam |
| | M. | Microtubule Assembly Inhibition | | |
| | | (WSSA Group 3) | | |
| | | 1. | Dinitroanilines | |
| | | | a. | Benfluralin |
| | | | b. | Butralin |
| | | | c. | Dinitramine |
| | | | d. | Ethalfluralin |
| | | | e. | Oryzalin |
| | | | f. | Pendimethalin |
| | | | g. | Trifluralin |
| | | 2. | Phosphoroamidates | |
| | | | a. | Amiprophos-methyl |
| | | | b. | Butamiphos |
| | | 3. | Pyridines | |
| | | | a. | Dithiopyr |
| | | | b. | Thiazopyr |
| | | 4. | Benzamides | |
| | | | a. | Pronamide |
| | | | b. | Tebutam |
| | | 5. | Benzenedicarboxylic acids | |
| | | | a. | Chlorthal-dimethyl |
| | N. | Inhibition of mitosis/microtubule | | |
| | | organization WSSA Group 23) | | |
| | | 1. | Carbamates | |
| | | | a. | Chlorpropham |
| | | | b. | Propham |
| | | | c. | Carbetamide |
| | O. | Inhibition of cell division (Inhibition of | | |
| | | very long chain fatty acids as proposed | | |
| | | mechanism; WSSA Group 15) | | |
| | | 1. | Chloroacetamides | |
| | | | a. | Acetochlor |
| | | | b. | Alachlor |
| | | | c. | Butachlor |
| | | | d. | Dimethachlor |
| | | | e. | Dimethanamid |
| | | | f. | Metazachlor |
| | | | g. | Metolachlor |
| | | | h. | Pethoxamid |
| | | | i. | Pretilachlor |
| | | | j. | Propachlor |
| | | | k. | Propisochlor |
| | | | l. | Thenylchlor |
| | | 2. | Acetamides | |
| | | | a. | Diphenamid |
| | | | b. | Napropamide |
| | | | c. | Naproanilide |
| | | 3. | Oxyacetamides | |
| | | | a. | Flufenacet |
| | | | b. | Mefenacet |
| | | 4. | Tetrazolinones | |
| | | | a. | Fentrazamide |
| | | 5. | Others | |
| | | | a. | Anilofos |
| | | | b. | Cafenstrole |
| | | | c. | Indanofan |
| | | | d. | Piperophos |
| | P. | Inhibition of cell wall (cellulose) | | |
| | | synthesis | | |
| | | 1. | Nitriles (WSSA Group 20) | |
| | | | a. | Dichlobenil |
| | | | b. | Chlorthiamid |
| | | 2. | Benzamides (isoxaben (WSSA | |
| | | | Group 21)) | |
| | | | a. | Isoxaben |
| | | 3. | Triazolocarboxamides (flupoxam) | |
| | | | a. | Flupoxam |
| | Q. | Uncoupling (membrane disruption): | | |
| | | (WSSA Group 24) | | |
| | | 1. | Dinitrophenols | |
| | | | a. | DNOC |
| | | | b. | Dinoseb |
| | | | c. | Dinoterb |
| | R. | Inhibition of Lipid Synthesis by other | | |
| | | than ACC inhibition | | |
| | | 1. | Thiocarbamates (WSSA Group 8) | |
| | | | a. | Butylate |
| | | | b. | Cycloate |
| | | | c. | Dimepiperate |
| | | | d. | EPTC |
| | | | e. | Esprocarb |
| | | | f. | Molinate |
| | | | g. | Orbencarb |
| | | | h. | Pebulate |
| | | | i. | Prosulfocarb |
| | | | j. | Benthiocarb |
| | | | k. | Tiocarbazil |
| | | | l. | Triallate |
| | | | m. | Vernolate |
| | | 2. | Phosphorodithioates | |
| | | | a. | Bensulide |
| | | 3. | Benzofurans | |
| | | | a. | Benfuresate |
| | | | b. | Ethofumesate |
| | | 4. | Halogenated alkanoic acids | |
| | | | (WSSA Group 26) | |
| | | | a. | TCA |
| | | | b. | Dalapon |
| | | | c. | Flupropanate |
| | S. | Synthetic auxins (IAA-like) (WSSA | | |
| | | Group 4) | | |
| | | 1. | Phenoxycarboxylic acids | |
| | | | a. | Clomeprop |
| | | | b. | 2,4-D |
| | | | c. | Mecoprop |
| | | 2. | Benzoic acids | |
| | | | a. | Dicamba |
| | | | b. | Chloramben |
| | | | c. | TBA |
| | | 3. | Pyridine carboxylic acids | |
| | | | a. | Clopyralid |
| | | | b. | Fluroxypyr |
| | | | c. | Picloram |
| | | | d. | Tricyclopyr |
| | | 4. | Quinoline carboxylic acids | |
| | | | a. | Quinclorac |
| | | | b. | Quinmerac |
| | | 5. | Others (benazolin-ethyl) | |
| | | | a. | Benazolin-ethyl |
| | T. | Inhibition of Auxin Transport | | |
| | | 1. | Phthalamates; semicarbazones | |
| | | | (WSSA Group 19) | |
| | | | a. | Naptalam |
| | | | b. | Diflufenzopyr-Na |
| | U. | Other Mechanism of Action | | |
| | | 1. | Arylaminopropionic acids | |
| | | | a. | Flamprop-M-methyl/- |
| | | | | isopropyl |
| | | 2. | Pyrazolium | |
| | | | a. | Difenzoquat |
| | | 3. | Organoarsenicals | |
| | | | a. | DSMA |
| | | | b. | MSMA |
| | | 4. | Others | |
| | | | a. | Bromobutide |
| | | | b. | Cinmethylin |
| | | | c. | Cumyluron |
| | | | d. | Dazomet |
| | | | e. | Daimuron-methyl |
| | | | f. | Dimuron |
| | | | g. | Etobenzanid |
| | | | h. | Fosamine |
| | | | i. | Metam |
| | | | j. | Oxaziclomefone |
| | | | k. | Oleic acid |
| | | | l. | Pelargonic acid |
| | | | m. | Pyributicarb |

Generally, a particular herbicide is applied to a particular field (and any plants growing in it) no more than 1, 2, 3, 4, 5, 6, 7, or 8 times a year, or no more than 1, 2, 3, 4, or 5 times per growing season. Generally, more than one herbicide is applied to a field in a growing season as would be required for adequate weed control. In addition, herbicides can be applied to a field after crop removal as a means of controlling weed populations.

By “treated with a combination of” or “applying a combination of” herbicides to a crop, area of cultivation or field is intended that a particular field, crop or weed is treated with each of the herbicides and/or chemicals indicated to be part of the combination so that desired effect is achieved, i.e., an improved yield while the weeds are selectively controlled and the crop is not significantly damaged. In some embodiments, weeds which are susceptible to each of the herbicides exhibit damage from treatment with each of the herbicides which is additive or synergistic. The application of each herbicide and/or chemical may be simultaneous or the applications may be at different times, so long as the desired effect is achieved. Furthermore, the application can occur prior to the planting of the crop.

In some embodiments, the additional herbicide of interest is applied with an effective amount at a dose equivalent to a rate of at least 0.5, 1, 2, 3, 4, 5, 6, 7, 8, 9, 10, 11, 12, 13, 14, 15, 20, 25, 30, 35, 40, 45, 50, 55, 60, 65, 70, 75, 80, 85, 90, 95, 100, 110, 120, 150, 170, 200, 300, 400, 500, 600, 700, 800, 800, 1000, 2000, 3000, 4000, 5000 or more grams or ounces (1 ounce=29.57 ml) of active ingredient per acre or per hectare, whereas an appropriate control plant is significantly damaged by the same treatment.

In some embodiments, the additional herbicide comprises a sulfonylurea herbicide which can be applied to a field and/or to at least one plant in a field at rates between 0.04 and 1.0 ounces of active ingredient per acre, or at rates between 0.1, 0.2, 0.4, 0.6, and 0.8 ounces of active ingredient per acre at the lower end of the range of application and between 0.2, 0.4, 0.6, 0.8, and 1.0 ounces of active ingredient per acre at the higher end of the range of application. (1 ounce=29.57 ml).

In specific embodiments, the additional herbicide comprises an effective amount of an ALS inhibitor herbicide comprises at least about 0.1, 1, 5, 10, 25, 50, 75, 100, 150, 200, 250, 300, 350, 400, 450, 500, 600, 700, 750, 800, 850, 900, 950, 1000, 2000, 3000, 4000, 5000, or more grams or ounces (1 ounce=29.57 ml) of active ingredient per hectare. In other embodiments, an effective amount of an ALS inhibitor comprises at least about 0.1-50, about 25-75, about 50-100, about 100-110, about 110-120, about 120-130, about 130-140, about 140-150, about 150-200, about 200-500, about 500-600, about 600-800, about 800-1000, or greater grams or ounces (1 ounce=29.57 ml) of active ingredient per hectare. Any ALS inhibitor, for example, those listed in Table 2 can be applied at these levels.

In other embodiments, the additional herbicide comprises an effective amount of a sulfonylurea and can comprise at least 0.1, 1, 5, 10, 25, 50, 75, 100, 150, 200, 250, 300, 350, 400, 450, 500, 600, 700, 800, 900, 1000, 5000 or more grams or ounces (1 ounce=29.57 ml) of active ingredient per hectare. In other embodiments, an effective amount of a sulfonylurea comprises at least about 0.1-50, about 25-75, about 50-100, about 100-110, about 110-120, about 120-130, about 130-140, about 140-150, about 150-160, about 160-170, about 170-180, about 190-200, about 200-250, about 250-300, about 300-350, about 350-400, about 400-450, about 450-500, about 500-550, about 550-600, about 600-650, about 650-700, about 700-800, about 800-900, about 900-1000, about 1000-2000, or more grams or ounces (1 ounce=29.57 ml) of active ingredient per hectare. Representative sulfonylureas that can be applied at this level are set forth in Table 2.

Additional ranges of the effective amounts of herbicides can be found, for example, in various publications from University Extension services. See, for example, Bernards et al. (2006) Guide for Weed Management in Nebraska (www.ianrpubs.url.edu/sendlt/ec130); Regher et al. (2005) Chemical Weed Control for Fields Crops, Pastures, Rangeland, and Noncropland, Kansas State University Agricultural Extension Station and Corporate Extension Service; Zollinger et al. (2006) North Dakota Weed Control Guide, North Dakota Extension Service, and the Iowa State University Extension at www.weeds.iastate.edu, each of which is herein incorporated by reference.

In the methods of the invention, the glyphosate or glyphosate-herbicide combination may be formulated and applied to an area of interest such as, for example, a field or area of cultivation, in any suitable manner. A herbicide may be applied to a field in any form, such as, for example, in a liquid spray or as solid powder or granules. In specific embodiments, the glyphosate or combination of glyphosate and additional herbicides of interest employed in the methods can comprise a tankmix or a premix. A herbicide may also be formulated, for example, as a “homogenous granule blend” produced using blends technology (see, e.g., U.S. Pat. No. 6,022,552, entitled “Uniform Mixtures of Pesticide Granules”). The blends technology of U.S. Pat. No. 6,022,552 produces a nonsegregating blend (i.e., a “homogenous granule blend”) of formulated crop protection chemicals in a dry granule form that enables delivery of customized mixtures designed to solve specific problems. A homogenous granule blend can be shipped, handled, subsampled, and applied in the same manner as traditional premix products where multiple active ingredients are formulated into the same granule.

Briefly, a “homogenous granule blend” is prepared by mixing together at least two extruded formulated granule products. In some embodiments, each granule product comprises a registered formulation containing a single active ingredient which is, for example, a herbicide, a fungicide, and/or an insecticide. The uniformity (homogeneity) of a “homogenous granule blend” can be optimized by controlling the relative sizes and size distributions of the granules used in the blend. The diameter of extruded granules is controlled by the size of the holes in the extruder die, and a centrifugal sifting process may be used to obtain a population of extruded granules with a desired length distribution (see, e.g., U.S. Pat. No. 6,270,025).

A homogenous granule blend is considered to be “homogenous” when it can be subsampled into appropriately sized aliquots and the composition of each aliquot will meet the required assay specifications. To demonstrate homogeneity, a large sample of the homogenous granule blend is prepared and is then subsampled into aliquots of greater than the minimum statistical sample size.

In non-limiting embodiments, the multi-mode of action glyphosate-tolerant plant comprises a sequence encoding a glyphosate N-acetyl transferase polypeptide and an EPSPS polypeptide, where the plant or the area of cultivation is treated with an effective amount of glyphosate to thereby improve the yield of said plant. In still further embodiments, the multi-mode of action glyphosate tolerate plant further comprises a sequence comprising the HRA mutation of the ALS polypeptide. Such methods to improve yield can comprises applying to the plant or area of cultivation an effective amount of glyphosate to thereby improve the yield of said plant and further applying an effective concentration of an additional herbicide, such as an ALS chemistry, to effectively control the weeds in said area of cultivation. Since ALS inhibitor chemistries have different herbicidal attributes, blends of ALS inhibitors plus other chemistries can provide superior weed management strategies including varying and increased weed spectrum, the ability to provide specified residual activity (SU/ALS inhibitor chemistry with residual activity leads to improved herbicidal activity which leads to a wider window between glyphosate applications, as well as, an added period of control if weather conditions prohibit timely application).

Blends also afford the ability to add other agrochemicals at normal, labeled use rates such as additional herbicides (a 3^{rd}/4^{th} mechanism of action), fungicides, insecticides, plant growth regulators and the like thereby saving costs associated with additional applications.

Any herbicide formulation applied over the glyphosate-tolerant plant can be prepared as a “tank-mix” composition. In such embodiments, each ingredient or a combination of ingredients can be stored separately from one another. The ingredients can then be mixed with one another prior to application. Typically, such mixing occurs shortly before application. In a tank-mix process, each ingredient, before mixing, typically is present in water or a suitable organic solvent. For additional guidance regarding the art of formulation, see T. S. Woods, “The Formulator's Toolbox—Product Forms for Modern Agriculture” Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; and Hance et al., Weed Control Handbook, 8th Ed., Blackwell Scientific Publications, Oxford, 1989, each of which is incorporated herein by reference in their entirety.

The article “a” and “an” are used herein to refer to one or more than one (i.e., to at least one) of the grammatical object of the article. By way of example, “an element” means one or more element.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, it will be obvious that certain changes and modifications may be practiced within the scope of the appended claims.

### EXPERIMENTAL

### Example 1

### Improved Yield of Soybean Event DP356043-5 in Ten Populations Adapted for the Southern Growing Region of the United States

Soybean with the GLYAT gene from event DP356043-5 and an EPSPS gene corresponding to the EPSPS described in S. R. Pagette et al (1995) Development, Identification, and Characterization of a Glyphosate-Tolerance Soybean Line. Crop Sci. 35:1451-1461 (herein incorporated by reference) were generated. The EPSPS event of the glyphosate-tolerant soybean line 40-3-2 and the GLYAT event of the glyphosate-tolerant soybean line DP356043-5 were brought together via conventional breeding to generate ten unique populations. The lines for each population were identified as containing the GLYAT event DP35604-3, the EPSPS event 40-3-2, or containing both the GLYAT and EPSPS events. Lines were grown in the summer season as a plant row yield trials (PRYT) near West Memphis, Arkansas. PRYT rows were 1.2 meters in length, with 76 cm between row spacing. Plots were sprayed 24 days following planting with 840 g ae/ha glyphosate and sprayed 44 days after planting with 1680 g ae/ha glyphosate. Maturity and yield data were collected for each line and analyzed using the PROC Mixed function of SAS (SAS Institute, Cary N.Y.). Yields were adjusted for maturity for valid comparisons. When pooling the three classes (GLYAT, EPSPS, GLYAT+EPSPS) over the ten populations, the GLYAT+EPSPS lines were significantly higher yielding (48.1 bu/acre) compared to the EPSPS lines (40.6 bu/acre) and the GLYAT lines (44.7 bu/ac).

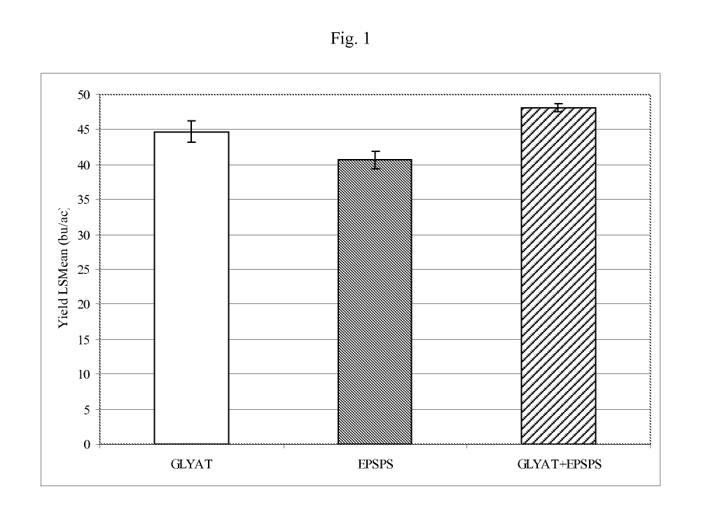

Table 3 shows the differences between LSMean estimates (bu/ac) for yield of ten different populations of related lines classified for glyphosate tolerance transgenes (GLYAT, EPSPS, GLYAT+EPSPS). FIG. 1 provides LSMean comparisons for yield (bu/ac) of ten different populations of lines classified for glyphosate tolerance transgenes (GLYAT, EPSPS, GLYAT+EPSPS). Lines were adapted to the Southern United States growing region.

TABLE 3

| Population | Herbicide1 | n1 | LSMean1 | Herbicide2 | n2 | LSMean2 | Difference | Probt |
|---|---|---|---|---|---|---|---|---|
| All | GLYAT | 80 | 44.7 | GLYAT + EPSPS | 575 | 48.1 | −3.5 | 0.032 |
| All | GLYAT | 80 | 44.7 | EPSPS | 129 | 40.6 | 4.0 | 0.040 |
| All | GLYAT + EPSPS | 575 | 48.1 | EPSPS | 129 | 40.6 | 7.5 | 0.000 |
| Population1 | GLYAT | 6 | 36.3 | GLYAT + EPSPS | 64 | 43.8 | −7.5 | NS |
| Population1 | GLYAT | 6 | 36.3 | EPSPS | 18 | 43.9 | −7.6 | NS |
| Population1 | GLYAT + EPSPS | 64 | 43.8 | EPSPS | 18 | 43.9 | −0.1 | NS |
| Population2 | GLYAT | 6 | 41.8 | GLYAT + EPSPS | 29 | 42.3 | −0.5 | NS |
| Population2 | GLYAT | 6 | 41.8 | EPSPS | 8 | 31.6 | 10.2 | NS |
| Population2 | GLYAT + EPSPS | 29 | 42.3 | EPSPS | 8 | 31.6 | 10.7 | 0.035 |
| Population3 | GLYAT | 9 | 47.6 | GLYAT + EPSPS | 88 | 51.7 | −4.1 | NS |
| Population3 | GLYAT | 9 | 47.6 | EPSPS | 21 | 47.1 | 0.4 | NS |
| Population3 | GLYAT + EPSPS | 88 | 51.7 | EPSPS | 21 | 47.1 | 4.6 | NS |
| Population4 | GLYAT | 6 | 33.8 | GLYAT + EPSPS | 43 | 39.1 | −5.2 | NS |
| Population4 | GLYAT | 6 | 33.8 | EPSPS | 5 | 25.2 | 8.6 | NS |
| Population4 | GLYAT + EPSPS | 43 | 39.1 | EPSPS | 5 | 25.2 | 13.9 | 0.021 |
| Population5 | GLYAT | 4 | 49.5 | GLYAT + EPSPS | 37 | 43.9 | 5.6 | NS |
| Population5 | GLYAT | 4 | 49.5 | EPSPS | 12 | 35.1 | 14.4 | 0.049 |
| Population5 | GLYAT + EPSPS | 37 | 43.9 | EPSPS | 12 | 35.1 | 8.8 | 0.036 |
| Population6 | GLYAT | 9 | 52.7 | GLYAT + EPSPS | 32 | 51.6 | 1.0 | NS |
| Population6 | GLYAT | 9 | 52.7 | EPSPS | 10 | 49.9 | 2.8 | NS |
| Population6 | GLYAT + EPSPS | 32 | 51.6 | EPSPS | 10 | 49.9 | 1.7 | NS |
| Population7 | GLYAT | 12 | 41.8 | GLYAT + EPSPS | 87 | 43.2 | −1.3 | NS |
| Population7 | GLYAT | 12 | 41.8 | EPSPS | 10 | 38.3 | 3.5 | NS |
| Population7 | GLYAT + EPSPS | 87 | 43.2 | EPSPS | 10 | 38.3 | 4.9 | NS |
| Population8 | GLYAT | 13 | 51.7 | GLYAT + EPSPS | 61 | 53.6 | −1.9 | NS |
| Population8 | GLYAT | 13 | 51.7 | EPSPS | 24 | 45.5 | 6.2 | NS |
| Population8 | GLYAT + EPSPS | 61 | 53.6 | EPSPS | 24 | 45.5 | 8.0 | 0.008 |
| Population9 | GLYAT | 10 | 50.7 | GLYAT + EPSPS | 70 | 61.1 | −10.4 | 0.015 |
| Population9 | GLYAT | 10 | 50.7 | EPSPS | 10 | 43.7 | 7.0 | NS |
| Population9 | GLYAT + EPSPS | 70 | 61.1 | EPSPS | 10 | 43.7 | 17.4 | 0.000 |
| Population10 | GLYAT | 5 | 40.6 | GLYAT + EPSPS | 64 | 51.0 | −10.4 | NS |
| Population10 | GLYAT | 5 | 40.6 | EPSPS | 11 | 46.0 | −5.4 | NS |
| Population10 | GLYAT + EPSPS | 64 | 51.0 | EPSPS | 11 | 46.0 | 5.0 | NS |

### Example 2

### Improved Yield of Soybean Event DP356043-5 in Two Populations Adapted for the Mid-Maturity Growing Region of the United States

Soybean with the DP356043-5 event and an EPSPS gene corresponding to the EPSPS described in S. R. Pagette et al (1995) Development, Identification, and Characterization of a Glyphosate-Tolerance Soybean Line. Crop Sci. 35:1451-1461 (herein incorporated by reference) were generated. The EPSPS event of the glyphosate-tolerant soybean line 40-3-2 and the GLYAT event of the glyphosate-tolerant soybean line DP356043-5 were brought together via conventional breeding to generate two unique populations. The lines for each population were identified as containing the GLYAT event DP35604-3, the EPSPS event 40-3-2, or containing both the GLYAT and EPSPS events. Lines were grown in the summer season as a plant row yield trials (PRYT) near Napoleon, Ohio. PRYT rows were 1.2 meters in length, with 76 cm between row spacing. Plots were sprayed 31 days after planting with 3360 g ae/ha glyphosate. Maturity and yield data were collected for each line and analyzed using the PROC Mixed function of SAS (SAS Institute, Cary N.Y.). Yields were adjusted for maturity for valid comparisons. When pooling the three across the two populations, the GLYAT+EPSPS lines were significantly higher yielding (45.6 bu/acre) compared to the EPSPS lines (41.4 bu/acre) and not significantly different compared to the GLYAT lines (45.8 bu/acre).

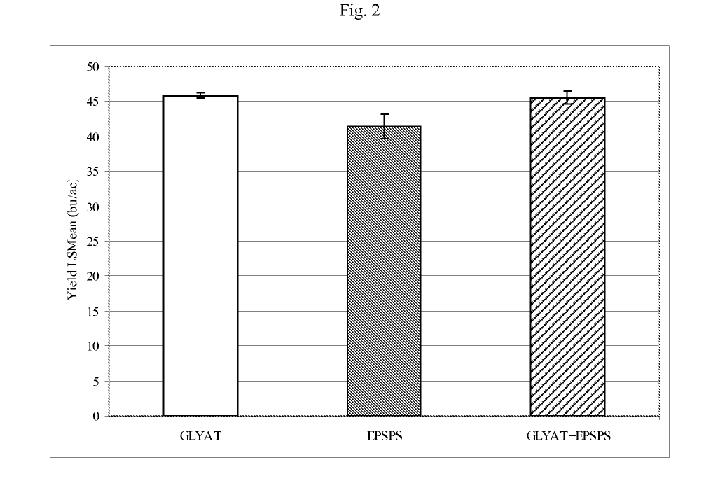

Table 4 shows the differences between LSMean estimates for yield of two different populations of lines classified for glyphosate tolerance transgenes (GLYAT, EPSPS, GLYAT+EPSPS). FIG. 2 provides LSMean comparisons for yield of two different populations of related lines classified for glyphosate tolerance transgenes (GLYAT, EPSPS, GLYAT+EPSPS). Lines are adapted to the Midwestern United States growing region.

TABLE 4

| | | | Yield | | | Yield | | |
|---|---|---|---|---|---|---|---|---|
| | Comparison | | LSMean1 | Comparison | | LSMean2 | Difference | |
| Population | Class 1 | N1 | Bu/acre | Class 2 | N2 | Bu/acre | Bu/acre | Probt |
| All | GLYAT | 619 | 45.8 | GLYAT + | 95 | 45.6 | 0.2 | NS |
| | | | | EPSPS | | | | |
| All | GLYAT | 619 | 45.8 | EPSPS | 21 | 41.4 | 4.4 | 0.016 |
| All | GLYAT + | 95 | 45.6 | EPSPS | 21 | 41.4 | 4.1 | 0.043 |
| | EPSPS | | | | | | | |
| Population1 | GLYAT | 219 | 49.2 | GLYAT + | 72 | 47.9 | 1.3 | NS |
| | | | | EPSPS | | | | |
| Population1 | GLYAT | 219 | 49.2 | EPSPS | 10 | 47.6 | 1.6 | NS |
| Population1 | GLYAT + | 72 | 47.9 | EPSPS | 10 | 47.6 | 0.3 | NS |
| | EPSPS | | | | | | | |
| Population2 | GLYAT | 400 | 42.4 | GLYAT + | 23 | 43.3 | −0.9 | NS |
| | | | | EPSPS | | | | |
| Population2 | GLYAT | 400 | 42.4 | EPSPS | 11 | 35.3 | 7.1 | 0.004 |
| Population2 | GLYAT + | 23 | 43.3 | EPSPS | 11 | 35.3 | 8.0 | 0.008 |
| | EPSPS | | | | | | | |

TABLE 5
Summary of SEQ ID NOs

| | | |
|---|---|---|
| SEQ ID | Sequence | |
| NO | type | Description |

| | | |
|---|---|---|
| 1 | DNA | GLYAT clone 13_6D10 |
| 2 | AA | GLYAT clone 13_6D10 |
| 3 | DNA | GLYAT clone 10_4H4 |
| 4 | AA | GLYAT clone 10_4H4 |
| 5 | DNA | GLYAT clone 0_5D3 |
| 6 | AA | GLYAT clone 0_5D3 |
| 7 | DNA | GLYAT clone D_S00261438_18_28D9 |
| | | (or GLYAT 4601) |
| 8 | AA | GLYAT clone D_S00261438_18_28D9 |
| | | (or GLYAT 4601) |
| 9 | DNA | GLYAT clone 4621 |
| 10 | AA | GLYAT clone 4621 |
| 11 | AA | Agrobacterium sp. CP4 EPSPS |
| 12 | DNA | HRA from Glycine max |
| 13 | DNA | HRA from Zea mays |
| 14 | DNA | HRA from Arabidopsis |
| 15 | AA | HRA from cotton |

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, it will be obvious that certain changes and modifications may be practiced within the scope of the appended claims.

That which is claimed:

1. A method for improving yield in a plant comprising treating said plant with an effective amount of glyphosate, wherein said plant has stably incorporated into its genome a first polynucleotide encoding a first polypeptide and a second polynucleotide encoding a second polypeptide, wherein each of said first and said second polypeptide impart tolerance to glyphosate by distinct modes of action.

2. The method of claim 1, wherein said first polynucleotide encodes a polypeptide having glyphosate N-acetyl transferase activity.

3. The method of claim 2, wherein said first polynucleotide encodes a polypeptide having at least 70% identity to SEQ ID NO: 2, 4, or 6.

4. The method of claim 2, wherein said first polynucleotide encodes a polypeptide having at least 80% sequence identity to SEQ ID NO: 8 or 10.

5. The method of claim 2, wherein said first polynucleotide encodes a polypeptide having at least 90% sequence identity to SEQ ID NO: 8 or 10.

6. The method of claim 2, wherein said first polynucleotide encodes a polypeptide set forth in SEQ ID NO: 8 or 10.

7. The method of claim 2, wherein said second polynucleotide encodes a glyphosate-tolerant 5-enol-pyruvylshikimate-3-phosphate synthase (EPSPS) polypeptide.

8. The method of claim 7, wherein said second polynucleotide encodes a polypeptide having at least 80% sequence identity to SEQ ID NO: 11.

9. The method of claim 2, wherein said first polynucleotide encodes a polypeptide having at least 90% sequence identity to SEQ ID NO: 8 and said second polynucleotide encodes a polypeptide having at least 90% sequence identity to SEQ ID NO: 11, wherein said plant is a soybean plant.

10. The method of claim 1, wherein the glyphosphate is applied in a single treatment or in successive treatments.

11. The method of claim 1, wherein the glyphosate is a glyphosate derivative comprising a salt or a mixture of glyphosate salts selected from the group consisting of: mono-isopropylammonium glyphosate, ammonium glyphosate, and sodium glyphosate.

12. The method of claim 1, wherein the glyphosphate or derivative thereof is used in a formulation comprising: an adjuvant selected from the group consisting of: amines, ethoxylated alkyl amines, tallow amines, cocoamines, amine oxides, quaternary ammonium salts, ethoxylated quaternary ammonium salts, propoxylated quaternary ammonium salts, alkylpolyglycoside, alkylglycoside, glucose-esters, sucrose-esters, and ethoxylated polypropoxylated quaternary ammonium surfactants.

13. The method of claim 2, wherein said second polynucleotide encodes a glyphosate oxidoreductase enzyme.

14. The method of claim 2, wherein said second polynucleotide encodes a class II EPSPS enzyme.
